(19) United States
(12) Patent Application Publication
(10) Pub. No.: US 2025/0325991 A1
(43) Pub. Date: Oct. 23, 2025

(54) Herb Grinder, Smoking Kit and Single Dose Smoking Device

(71) Applicant: Jeffrey W. Sand, San Francisco, CA (US)

(72) Inventor: Jeffrey W. Sand, San Francisco, CA (US)

(21) Appl. No.: 19/059,250

(22) Filed: Feb. 20, 2025

Related U.S. Application Data
(60) Provisional application No. 63/555,844, filed on Feb. 20, 2024.

(51) Int. Cl. B02C 18/08; A24B 7/06; A24F 3/02; A24F 7/02; A24F 9/10; A24F 9/16; A24F 15/18; F23Q 2/32

(52) U.S. Cl. CPC B02C 18/08; A24F 3/02; A24F 9/16; A24F 15/18; A24B 7/06; A24F 7/02; A24F 9/10; F23Q 2/32

(57) ABSTRACT

A portable herb grinder consists of a grinder sector and a hopper sector, a portable herb grinder where the grinder and hopper sectors are combined, a portable herb grinder that is included as part of a kit which includes a lighter, a smoking device and a storage area for herbaceous or similar smoking materials, and a novel arrangement for a case that includes a lighter, a smoking device stored in the case, a grinder stored in the case, and space for storing herbaceous smoking materials in the case, and a novel arrangement of a single dose smoking device for smoking herbaceous materials or the like.

The present invention provides a portable herb grinder consisting of a grinder sector and a hopper sector, a portable herb grinder where the grinder and hopper sectors are combined, a portable herb grinder that is included as part of a kit which includes a lighter, a smoking device and a storage area for herbaceous or similar smoking materials, and a novel arrangement for a case that includes a lighter, a smoking device stored in the case, a grinder stored in the case, and space for storing herbaceous smoking materials in the case, and a novel arrangement of a single dose smoking device for smoking herbaceous materials or the like.

### BACKGROUND OF THE INVENTION

The present invention provides a manually operated herb grinder consisting of a grinder sector and a hopper sector and a manually operated herb grinder where the grinder sector and hopper sector can be separate or combined.

U.S. Pat. No. 6,945,486 teaches a herb grinder consisting of a set of two nesting cylinders with disk-shaped bottoms having protruding grater elements extending from each disk-shaped bottom toward the other disk-shaped bottom. The grater elements on each disk-shaped bottom are made of protruding elements or bosses with recesses between them, and the recesses and projections of each grater element closely interlocks with the recesses and projections of the other grater element on the other nesting cylinder such that material caught between the projections or bosses will be ground into particle sizes that can pass between the space between the projections or bosses. Herbaceous or vegetable material is placed inside the nesting cylinders and then the material is grated by hand-applied, counter-twisting forces on each of the nesting cylinders.

US Patent Publication 2014/0217213 teaches a nesting arrangement of paired cylinders with opposing and cooperating bosses that rotate past each other in a shearing motion that is similar to U.S. Pat. No. 6,945,486. The bosses are formed with serrations for engaging and shearing the dried herbaceous materials between the faces of the protruding bosses in order to produce a ground output when the first disk or element is rotated relative to the second disk or element on a shared axis common to the first element and the second element. Additionally the device further comprises openings in the base plate for discharging the ground material from the first grinding chamber into a second hopper chamber. US Patent Publication 2014/0217213 is concerned with reducing the force required to grind the herbaceous material. It uses various methods to make sharp edges on the concentrically arranged bosses that rotate past each other. The inventors note that sharpening the edges of the four-sided bosses taught in the prior art patent application requires expensive lathe and milling operations.

Similarly, U.S. Pat. No. 11,207,695 has the same concentric rotatable top and bottom disks or element but the bosses are asymmetric triangular-shaped members, rather than the largely four-sided bosses of US Patent Publication 2014/0217213. Like US Patent Publication 2014/0217213, U.S. Pat. No. 11,207,695 relies on sharp edges to shear the herbaceous materials. The problem with these teachings is that when the full length of the cutting edge of a first boss meets the corresponding full length cutting edge of an opposed, cooperating boss on the other element, a peak load is generated requiring a lot of force to cut the herbaceous material.

Many grinders have a grinding sector and a hopper sector. The herbaceous material is ground or sheared in the grinder sector and then when the ground materials are small enough, the ground materials pass through openings in the floor of the grinder sector into the hopper sector. To dispense the ground material from the hopper sector a cover that overlies an opening in the sidewall of the hopper sector is moved and the ground material is “poured” out. Pouring out sticky ground materials can be difficult as the sticky materials tend to clump together making it difficult to pour out small amounts of the ground materials while leaving ground materials in the hopper to be stored there for later use. US Patent publication 2014/0319249 teaches a hopper sector with an operable side door for allowing the cut herb material to escape, but the user must both rely on gravity and shake the whole grinder to get the material to exit through the door, making it difficult to remove only a small amount of material at any one time.

The present invention also provides an improved smoking device for combusting metered doses of herbaceous material.

Single dose smoking devices are preferred tools for smoking controlled amounts of herbaceous material as the small bowl size limits the amount of smoking material that can be smoked at a given time. The prior art of which the inventor is aware teaches a tubular form with a mouthpiece at one end and a bowl for containing and combusting the smokable materials at the opposing end. US Patent Publication 2012/0186592A1 is an example of this type of smoking device. US Patent Publication 2012/0186592A1 teaches a removable mouthpiece attached to a center shank portion that allows for a small disk-shaped filter or baffle to be placed in the dedicated cavity to protect the filter from burning embers.

US Patent Publication 20100/078035 teaches a mechanism to adjust the depth of the bowl in which the material to be smoked is placed. The invention uses a threaded coupling between the base of the bowl and the shank such that the depth of the bowl and thus the amount of material to be smoked can be adjusted.

The inventor feels there are a number of problems with the single dose smoking devices of which the inventor is aware. Ash and tars build up inside the devices which undermine the user's experience. The tars and ash can increase the harshness of the smoking experience, and the tars and ash can restrict and easily clog the airway within the device. Further the small bores are difficult to clean, and it is difficult to to confirm that they are clean.

The single dose smoking devices of which the inventor is aware also tend to burn the smoking material slowly and the smoking material is not burned uniformly. Generally, the material in the inner portions of the bowl combusts first, followed by the smoking material at the outside periphery of the bowl. This undermines the user's experience as the draw of smoke feels thin, and is less than expected. Further because the burning of the herbaceous material is not uniform and quick, the burning of the smoking material tends to be inconsistent, even if the material being smoked is all of similar size and consistency.

The present invention also provides a kit of smoking accessories, including a grinder, a single dose smoking device, a lighter and a space to store herbaceous materials. The present invention also provides a pocket-sized device or case that integrates separate tools used for the preparation and smoking of herbaceous materials. The device stores the ground material. The device stores the smoking device for smoking the ground material when the smoking device is not being used. In one embodiment of the invention, the smoking device is connected to the device with the use of magnets. The device or case also includes an integrated lighter. The device has a grinder that is preferably integrated into the hopper door where the user accesses the ground materials.

The smoking system as described in U.S. Pat. No. 4,214,658 teaches a smoking system to hold a smoking pipe and smoking material in one compact container. This patent is similar to many products on the market in that it teaches a largely rectangular device with two compartments. One of the compartments is used to store a pipe and the other compartment is used to store the herbaceous material to be smoked. U.S. Pat. No. 4,214,658 shows a cylindrical closed-end bore with a spring-like element at the bottom of the closed-end bore such that the largely cylindrical pipe drops into the bore. The spring-like element at the base of the bore pushes the pipe element out just enough for the user to grasp and remove it from the vessel. Rectangular box-like devices, having a storage hopper and a dedicated smoking device stowing area are commonly referred to as dugouts. The inventor has observed that all the dugouts of which they are aware teach a rectangular-shaped box with an interior hollow or cavity that is used as a storage hopper. The box is made with a cap to access the storage hopper which is affixed at a narrow end of the rectangular-shaped box. The cap is typically rotated to access the storage hopper. In the case of U.S. Pat. No. 4,214,658 the cap is slid along a track in the narrow end of the box to access the storage hopper.

There are a number of problems associated with these dugouts where the storage hopper is accessed through the narrow end of the rectangular box-like device. First, these prior art devices lack integrated grinders, such that the user needs a separate grinder device. Filling the dugout's storage hopper with ground material from the storage hopper of a grinder is difficult because the ground material tends to clump together and the clumps can be larger than the small opening in the top of the narrow end of the typical dugout. Having the opening at the narrow end of the long rectangular vessel also makes it difficult to see the volume of contents in the vessel. Storing a cylindrical pipe component or smoking device in a closed-bottomed bore results in the bore filling with ash which contaminates the smoking device, resulting in an unclean smoking device. When ash and other contaminants are present on the smoking device and ingested by the user, they are perceived as a harness to the smoking experience that is unpleasant. This problem is hard to rectify as the small bores in the dugout are hard to clean. Most prior art dugouts also do not include an integrated lighter, so the user needs to carry a separate mechanism to light the smoking materials. Some prior art dugouts have a space to hold common disposable lighters present on the market; however, such dugouts are inefficient in their use of space.

### SUMMARY OF THE INVENTION

The present invention provides a manually-operated portable herb grinder, wherein the top and bottom grinder elements have bosses or projections with recesses between them arranged in a reciprocating manner such that bosses of the top grinder element can slide past the bosses of the bottom grinder element in a shearing action, when the top and bottom grinder elements are rotated with respect to each other. The top and bottom grinder elements matingly engage with each other such that they can be rotated with respect to each other along a common axis of rotation to create the grinding action.

The present invention provides a manually-operated portable herb grinder, wherein the top grinder element removably attaches to the bottom grinder element without the use of tools. The upper grinder element can have a magnet that is installed in an extension that is in close proximity to a portion of the lower grinder element. The lower grinder element has a corresponding magnet that is installed in a cavity that is in close proximity to the magnet in the upper grinder element when the grinder is assembled. The poles of magnets are arranged so that the magnets attract each other when placed in close proximity such that the upper and lower grinder elements are retained together during storage and operation of the grinder, but can be separated by the user pulling the grinder elements apart. The components of the grinder can also be held together by the use of a threaded screw that can be operated with a lobed handle such that no tools are needed to turn the screw.

The present invention provides a portable grinder where the user can accurately and easily dispense the ground materials. In one embodiment of the present invention, the opening or port from which material in the hopper sector is dispensed is positioned radially on the sidewall of the hopper. In another embodiment of the present invention, the opening or port from which material in the combined grinder and hopper sector is dispensed is positioned radially on the sidewall of the bottom grinder element. To help solve the problem of accurate dispensing, the hopper sector or the combined grinder and hopper sector in the present invention employs an impeller or wiper that collects the ground herbaceous material and moves it to the periphery or sidewall of the device. Further the grinder has a mechanism for opening or uncovering the exit opening in the sidewall of the grinder a variable amount to assist with metering out the ground material. To dispense material the user selects how much of the opening in the sidewall of the grinder will be uncovered and then rotates the impeller to dispense material. The arrangement of the dispensing mechanisms and their operation make it easy for the user to observe and control how much ground material exits the opening in the sidewall. The use of an impeller and a mechanism for changing the amount of the exit opening that is exposed allows for controllable increments of material to be dispensed.

The present invention provides a manually-operated herb grinder where the grinder can be operated by the user with a reasonable amount of counter-rotational force, making the grinding process easy and enjoyable for the user. The present invention achieves this in part by employing one or more diagonal pusher bosses that introduce a scissor-like shear action as the diagonal pusher boss push herb material in the direction of the filter holes between the grinder sector and the hopper sector, or towards the floor of the bottom grinder element. The present invention also achieves this object in part by making the grinding bosses smaller in height the farther the bosses are disposed from the axis on which the grinder elements turn. This means that less material can be ground at the periphery of the disks where more force is needed, making operation by the user easier. This is achieved by making the grinder sector with a concave roof for the upper grinder element and/or a concave floor for the lower grinder element such that the diagonal pusher bosses and the regular bosses are smaller at the periphery of the grinder sector.

The present invention provides a grinder that is inexpensive to manufacture. The grinding mechanisms of the present invention can be formed through just molding plastic or metal, thus there is no need for expensive machining operations.

The present invention in one embodiment provides a grinder having bosses that have rounded edges such that the herbaceous material is ground by means of the interaction of dull surfaces on the bosses, rather than sharp cutting edges.

The present invention provides a grinder that is compact. In one embodiment of the present invention, the grinder of the present invention is made with a flip-up handle, thus the grinder handle when not used takes up a minimal amount of space. The flip-up handle provides a convenient hand grip when used, but when in the stored position the grinder is hardly much taller. In another embodiment of the present invention, the impeller wiper for pushing ground materials out the port also acts as the upper part of the grinder, during the grinding operation. This enables the grinder sector and the hopper sector to be combined.

The present invention also provides a smoking device that improves the user experience by improving the efficiency and effectiveness of the burning of the smoking materials. In prior art devices known to the inventor, the smoking material burns in an inconsistent manner because air cannot reach the material in both the middle and end of the bowl as well as it does at the forward end of the bowl. The present invention has air slots that are positioned radially around the circumference of the bowl enabling a more uniform and complete burning of the material, improving the user's experience. Further the invention makes more efficient use of the smoking material, because the material is more fully combusted rather than being only partially burned.

The present invention provides a smoking device that allows for easy control of the dosage of materials to be smoked. The size of the dose to be burned is further controlled because the material burns consistently each time.

Single dose smoking devices invariably become dirty with tars and ash residue which undermines the user's experience by clogging the airway and imparting a harshness to the user's experience. The present invention provides a smoking device that is less likely to be subject to excessive harshness and clogging. Due to the design, arrangement and connection of the parts of the device the smoking device of the present invention is easy to keep clean.

The single dose smoking device has a user-actuated, bowl-ejection system. The bowl-ejection system is easy to use and ejects all of the ash and most of the tar in a reliable manner.

The smoking device of the present invention is easily assembled and disassembled without the use of tools. Critical internal surfaces of the device can be exposed for inspection and cleaning. Toolless assembly is made possible by the use of snap-fit connections. In one embodiment, the mouthpiece is formed with a pair of prongs that matingly engage with the rear end of the plunger in a snap-fit connection. In one embodiment, the mouthpiece is fastened to a plunger by a separate snap-fit connector. The plunger and the mouthpiece have surfaces that capture the hollow tubular body of the smoking device between them as well as the ejection spring. In one embodiment, a snap-fit connector is used to connect the mouthpiece to the plunger, and the snap-fit connector has a spring mechanism that allows for easy engagement and disengagement. The preferred snap-fit connector is a bi-directional snap fit member that engages both the mouthpiece and the plunger. The snap-fit connector is received by the mouthpiece, and in turn receives a portion of the plunger. The preferred material of the snap-fit connector is metal.

The present invention of the smoking device can be made with a ceramic mouthpiece, if desired. The steel wire snap-fit connector can be formed with a partial ring portion that is captured in a portion of the mouth piece such that the snap-fit connector cannot move axially with respect to the mouth piece. When the snap-fit connector is positioned in the mouth piece, the partial ring portion can be displaced radially and outwardly when an internal, outward force is imposed and then spring back to a smaller diameter, resting arrangement when the force is no longer imposed. In this manner, an enlarged or spherical end of the plunger can pass through the snap-fit connector, and then the snap-fit connector can engage a reduced-diameter neck of the plunger. Once the enlarged end has passed the snap-fit connector, the partial ring returns to its former or resting shape and captures the end of the plunger and with it the entire assembly.

The present invention provides a smoking device that easily accepts accessory filter elements. The filters fit in the end of the mouthpiece of the unit.

This present invention also has a unique system of components and their arrangement that creates mechanical filtration by forcing the smoke and air mixture through a convoluted path that reduces harshness, cools the draw and helps prevent still-burning embers from being taken up by the user.

The present invention provides for a kit of smoking accessories and devices, including a single dose smoking device, a grinder, a storage area for herbaceous materials, and a lighter. The present invention also provides a receptacle or case that can hold a smoking device, includes a lighter, and includes a grinder and storage area for herbaceous materials. In one embodiment, the case strategically positions the lighter and the access door to the hopper storage area in a compact and efficient manner. The case of the present invention is configured as a largely rectangular device where the hopper is positioned in the lower segment of the rectangular device and a lighter is positioned in the upper segment. This arrangement enables sufficient room for a standard or jet lighter mechanism whose use is both familiar and ergonomic. Moreover placing the hopper below the lighter provides the user with a relatively large hopper area. The use of a side door in the largest side surface of the rectangular box enables the user to easily visualize the volume of the contents of the hopper sector. The use of a large side door in the largest side surface of the rectangular box also allows the user to easily access the contents of the hopper sector for loading the dose-control smoking device, and because the door size is bigger than those of prior art dugouts, filling the grinder and or the hopper sector is easier.

The present invention provides a case with a side door and integrated grinder having the advantages of the above-described grinder. The present invention enables a small grinder to be integrated into the access door of the hopper. This has the advantage of eliminating the need for users to purchase and keep track of a stand alone grinder. Further the placement of the grinder in the large side face of the rectangular box-like device allows for a compact configuration of the device.

The present invention provides a case with a small, pocket-sized form factor. The present invention provides an overall form factor which is able to fit in a garment pocket, such as the front pocket of a pair of jeans. This is enabled by the arrangement described above, namely placing the lighter above the hopper. The size of the lighter provided in the box is also reduced by the innovation of using an upward-action trigger for the lighter, and using an open nest for holding the smoking device.

The prevention invention provides a box-like device or case which has a side-loading pipe storage area or nest. The nest for the smoking device is open on one side. Because the smoking device is not held in a mostly enclosed canister that can entrap undesirable residue from using the smoking device, a smoking device stored in the nest of the present invention is less likely to accumulate ash and other residues from the use of the smoking device. The storage device preferably holds the smoking device by means of magnets located on a concave wall of the storage device. By not fully enclosing the smoking device, the case or storage device can be smaller in size.

The present invention also provides a cap or seat for the smoking device storage area. The protrusion or cap of the side-loading smoking device storage area fits over the inlet end of the single dose smoking device of the present invention closing off the inlet end. The cap provides a positive bottom when the user places the pipe into its side loading nest thereby eliminating the need for the user to visually position the pipe assembly in a position for portability. Providing a cap for the end of the single dose smoking device provides protection from any ash or tar build-up that might fall into the user's preferred stowage for the case, be it a handbag or pocket. If there are un-smoked contents in the inlet end of the single dose smoking device the cap can be utilized to make sure that contents stay in the single dose smoking device for later consumption.

The present invention provides a reduced form-factor for the case. Further size reduction is achieved with the deployment of the flip-up handle for the grinder that is part of the case. The flip-up handle can be rotated upwardly 90 degrees so that the user has access to a larger gripping surface and can securely rotate the upper grinder element. When not in use the handle folds into the upper surface of the upper grinder element, taking up a minimum amount of space.

The present invention provides a reduced form factor by forming the flip-up handle for the upper grinder sector with a spring wire hinge pin. The flip-up handle has an eccentric rotation whereby a cam surface on the flip-up handle follows a top surface on the upper grinder element, causing the hinge pin to deflect, when the flip-up handle is moved from a flat, resting position to an orthogonal, engaged position, and back. The force of this deflection is used to hold the flip-up handle in the upward position for operating the grinder, and similarly in the closed position where it is nested into a like-sized depression in the grinder top surface of the upper grinder element.

### DESCRIPTION OF THE DRAWINGS

FIG. 1 is a top view of a grinder according to the present invention.

FIG. 2 is a side view of the grinder of FIG. 1.

FIG. 3. is a bottom view of the grinder of FIG. 1.

FIG. 4 is a top view of an alternate embodiment of a grinder of the present invention.

FIG. 5 is a side view of the grinder of FIG. 4.

FIG. 6 is a bottom view of the grinder of FIG. 4.

FIG. 7 is an enlarged, exploded view of the grinder of FIG. 1.

FIG. 8 is a top view of the grinder of FIG. 1 with the grinder rotated.

FIG. 9 is a section side view of the grinder of FIG. 8 taken along the section line shown in FIG. 8.

FIG. 10 is a perspective view of the grinder of FIG. 8 with portions of the grinder cut away to show internal mechanisms.

FIG. 11 is a top view of the grinder of FIG. 8 with the flip-up handle in its raised position.

FIG. 12 is an exploded view of the grinder shown in FIG. 10 with the portions of the grinder cut away to show internal mechanisms.

FIG. 13 is a perspective view of the grinder of FIG. 8 with portions of the grinder cut away to show internal mechanisms. Arrows show the rotational movement of the flip-up handle and the wiper to which it connects. An additional arrow shows the path ground material takes to exit the integrated grinder and hopper sector when the cover for the port in the sidewall of the integrated grinder and hopper sector is uncovered and the wiper is actuated.

FIG. 14 is an exploded view of the grinder of FIG. 1.

FIG. 15 is an exploded view of an alternate embodiment of a grinder of the present invention.

FIG. 16 is a top view of the grinder of FIG. 15.

FIG. 17 is a side view of the grinder of FIG. 15.

FIG. 18 is a bottom view of the grinder of FIG. 15.

FIG. 19 is a perspective view of the grinder of FIG. 15 with portions of the grinder cut away to show internal mechanisms.

FIG. 20 is a perspective view of the grinder of FIG. 15.

FIG. 21 is an exploded view of the grinder of FIG. 15.

FIG. 22 is an alternate, exploded view of the grinder of FIG. 15.

FIG. 23 is an exploded view of an alternate embodiment of a grinder of the present invention.

FIG. 23A is an exploded view of the wiper and actuator of the embodiment of the grinder of FIG. 23.

FIG. 23B is an enlarged view of the detail shown in FIG. 23.

FIG. 23C is an enlarged view of the detail shown in FIG. 23.

FIG. 23D is an enlarged view of the detail sown in FIG. 23.

FIG. 24 is a side view of the grinder of FIG. 23.

FIG. 25 is sectional, side view of the grinder of FIGS. 23 and 24 taken along the section line shown in FIG. 24.

FIG. 26 is a top view of the bottom grinder element and sleeve body of the grinder of FIGS. 23 and 24 with the bottom grinder element and the sleeve body in a first selected relative rotational orientation such the roof surface of the sleeve body does not block the openings in the bottom grinder element.

FIG. 26A is an enlarged view of one of the openings in the bottom grinder element shown in FIG. 26.

FIG. 27 is a top view of the bottom grinder element and sleeve body of the grinder of FIGS. 23 and 24 with the bottom grinder element and the sleeve body in a second selected relative rotational orientation such the roof surface of the sleeve body partially blocks the openings in the bottom grinder element.

FIG. 27A is an enlarged view of one of the openings in the bottom grinder element shown in FIG. 27.

FIG. 28 is an exploded view of the bottom grinder element and sleeve body of the grinder of FIGS. 23 and 24.

FIG. 29 is a top view of the top grinder element of the grinder of FIG. 16 with the flip-up handle in the raised position.

FIG. 30 is a sectional, side view of the top grinder element of FIG. 29 taken along the section lines of FIG. 29.

FIG. 31 is a side view of the top grinder element of the grinder of FIG. 16.

FIG. 32 is a sectional side view of the bottom grinder element of the grinder of FIG. 16.

FIG. 33 is a perspective view of the floor of a bottom grinder element with the sidewalls of the grinder element removed.

FIG. 33A is an enlarged view of one of the protruding bosses of the bottom grinder element shown in FIG. 33.

FIG. 34 is a perspective view of the floor of a bottom grinder element with the sidewalls of the bottom grinder element removed.

FIG. 34A is an enlarged view of one of the protruding bosses of the bottom grinder element shown in FIG. 34.

FIG. 35 is a perspective view of the floor of an alternate bottom grinder element with the sidewalls of the bottom grinder element removed.

FIG. 36 is an enlarged view of one of the protruding bosses of the bottom grinder element shown in FIG. 35.

FIG. 37 is a sectional side view of the single dose smoking device of the present invention.

FIG. 37A is an enlarged view of the detail circled in FIG. 37.

FIG. 38 is a sectional side view of the single dose smoking device of the present invention, showing the mouthpiece pushed towards the inlet end of the single does smoking device such that the plunger extends out of the inlet end of the single dose smoking device.

FIG. 39 is an exploded view of an alternated embodiment of the single dose smoking device.

FIG. 40 is a partial, sectional side view of the single dose smoking device of FIG. 37. The tubular body of the smoking device has been sectioned to show the inner mechanisms of the smoking device.

FIG. 40A is an enlarged view of the detail circled in FIG. 40.

FIG. 41 is an exploded view of the single dose smoking device shown in FIG. 37.

FIG. 42 is a side view of the mouthpiece joined to the plunger of the single dose smoking device shown in FIG. 37.

FIG. 43 is a sectional side view of the mouthpiece joined to the plunger of the single dose smoking device shown in FIG. 37.

FIG. 43A in an enlarged view of the detail circled in FIG. 43.

FIG. 44 is a side view of the single dose smoking device shown in FIG. 37.

FIG. 45 is sectional side view of the single dose smoking device shown in FIG. 44 taken along the section line of FIG. 44.

FIG. 45A is an enlarged view of the detail circled in FIG. 45.

FIG. 46 is a partial, sectional perspective view of the single dose smoking device shown in FIG. 37. The tubular body of the smoking device has been sectioned. The smoking device is also shown with a filter inserted in the mouthpiece.

FIG. 47 is an exploded view of the single dose smoking device of FIG. 46, showing the filter removed from the mouthpiece.

FIG. 48 is a side view of the single dose smoking device of FIG. 46.

FIG. 49 is an exploded, perspective view of the single dose smoking device of FIG. 46.

FIG. 50 is an exploded view of the single dose smoking device of FIG. 46, showing the filter as well.

FIG. 51 is a perspective view of the mouthpiece and plunger of the device of FIG. 46 shown connected to each other.

FIG. 52 is a side view of the mouthpiece and plunger of the device of FIG. 46 shown connected to each other.

FIG. 53 is a sectional, side view of the mouthpiece and plunger connected to each other as shown in FIG. 52 taken along the section line of FIG. 52.

FIG. 53A is an enlarged view of the detail circled in FIG. 53.

FIG. 54 is a partial, sectional perspective view of the single dose smoking device shown in FIG. 37. The tubular body of the smoking device has been sectioned. The smoking device is shown without a filter inserted in the mouthpiece.

FIG. 55 is a partial, sectional side view of the single dose smoking device shown in FIG. 37. The tubular body of the smoking device has been sectioned to show the internal mechanisms.

FIG. 55A is an enlarged view of the detail circled in FIG. 55.

FIG. 56 is a side view of the single dose smoking device shown in FIG. 46. A filter is shown inserted into the mouthpiece of the device.

FIG. 57 is a side view of the single dose smoking device shown in FIG. 56 taken along the section line of FIG. 56.

FIG. 57A shows the inlet end of the single does smoking device of FIG. 57.

FIG. 58 is an exploded view of the case of the present invention showing the top grinder element removed from the bottom grinder element that is incorporated into the access door for the hopper sector of the case.

FIG. 59 is an exploded view of the case and kit of the present invention showing the case and single dose smoking device that can be held by the case. The single dose smoking device shown in FIG. 59 is the same single dose smoking device shown in FIG. 46 with a filter contained in the mouthpiece.

FIG. 60 is a perspective view of the case of the present invention, showing a flame emerging from the lighter incorporated into the case.

FIG. 61 is a front view of the case of the present invention, showing the single use smoking device held by the case, and the access door of the case is in the closed position and the top grinder element is held in place over the bottom grinder element of the grinder sector.

FIG. 62 is a perspective view of the case of the present invention, showing the access door to the hopper sector in the fully closed position.

FIG. 63 is a sectional side view of the kit of the present invention taken along the section line of FIG. 61. The section line passes through grinder sector and the hopper sector.

FIG. 64 is a exploded view of the kit of the present invention, showing the lighter, the case, the bottom grinder element that is part of the access door to the hopper sector, the top grinder element that attaches to the bottom grinder element and serves as part of the access door to enclose the hopper sector, the lighter and the single dose smoking device.

FIG. 65 is a perspective view of the main body of the access door showing the bottom grinder element incorporated into the main body.

FIG. 65A is an enlarged view of the detail circled in FIG. 65.

FIG. 66 is a side view of the top grinder element of the grinder of the present invention and the top grinder element shown in FIG. 58.

FIG. 67 is a top view of the main body of the access door of the case of the present invention with the top grinder element held in place over the main body of the access door.

FIG. 68 is a sectional, side view of the main body of the access door and top grinder element shown in FIG. 67, taken along the section line of FIG. 67.

FIG. 69 is a perspective view of the case of the present invention, with the single dose smoking device being held by the case.

FIG. 70 is a top view of the case shown in FIG. 69.

FIG. 71 is a left side view of the case shown in FIG. 69.

FIG. 72 is a front view of the case shown in FIG. 69.

FIG. 73 is an exploded view of the kit shown in FIG. 69, with the single dose smoking device in position to be lighted by the lighter which has been actuated and is issuing a flame.

FIG. 74 is a partial sectional view of the case of the present invention, showing the operation of the actuator for the lighter.

FIG. 75 is a schematic view of an alternate case of the present invention, showing the operation of the actuator for the lighter.

FIG. 76 is a perspective view of the alternate case of the present invention shown schematically in FIG. 75, with the access door for the hopper sector shown in the open position.

### DETAILED DESCRIPTION OF THE INVENTION

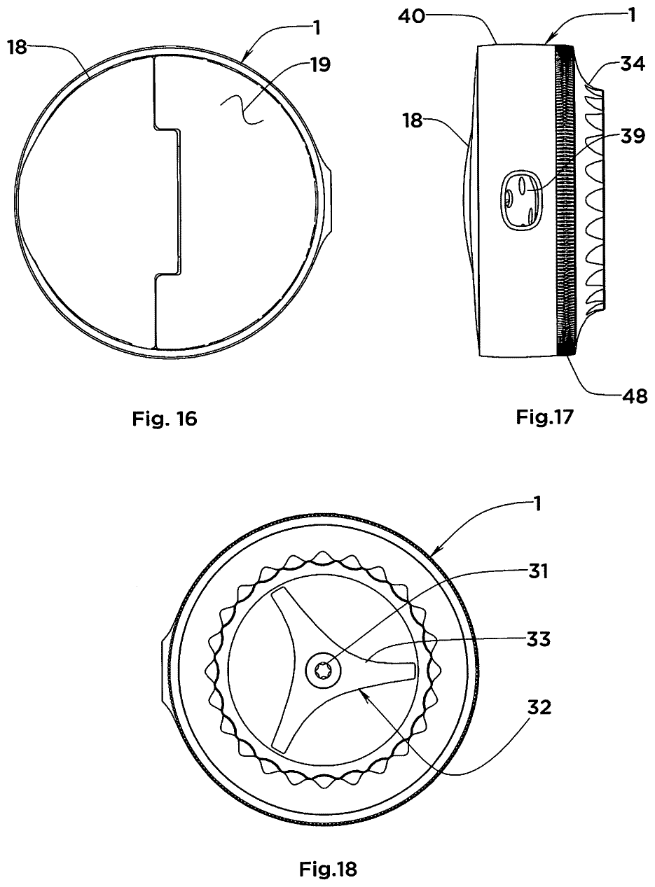

As shown in FIGS. 16-22, in one embodiment of a grinder 1 of the present invention, the grinder is divided into a grinder sector 2 and a hopper sector 3. The grinder sector 2 is formed with a top grinder element 4 or grinder cap and a bottom grinder element 5 that mates with the top grinder element. The top grinder element 4 and the bottom grinder element 5 are preferably formed from metal, but they can also be formed from other moldable materials such as plastic. The top grinder element 4 and the bottom grinder element 5 are preferably formed so that the bottom grinder element 5 can receive and be coupled to the top grinder element 4 in a manner that allows for rotation of the top grinder element 4 with respect to the bottom grinder element 5 when the parts are assembled together. The top grinder element 4 and bottom grinder element 5 are preferably able to be joined together in a manner that allows for their assembly and dis-assembly without the use of tools.

The top grinder element 4 is preferably formed with a dependent projection 6 at its center. The dependent projection 6 extends from the lower surface 7 of a roof 8 of the top grinder element 4, preferably at the center of the top grinder element 4. The dependent projection 6 of the top grinder element 4 is formed with a blind bore 9 with an opening 10 at the lower end of the dependent projection 6. The dependent projection 6 preferably receives and holds a first magnet 11 in the opening 10 in the lower end of the dependent projection 6. The first magnet 11 can be glued into the opening 10 or held by friction or other mechanical means.

The bottom grinder element 5 is preferably formed with an upstanding projection 12 at its center. The upstanding projection 12 extends from the upper surface 13 of the preferably non-flat floor 14 of the bottom grinder element 5, preferably at the center of the bottom grinder element 5. The upstanding projection 12 of the bottom grinder element 5 is formed with a blind bore 15 with an opening 16 at the upper end of the upstanding projection 12. The opening 16 at the upper end of the blind bore 15 in the upstanding projection 12 preferably receives and holds a second magnet 17 in place. When the top grinder element 4 is set in the appropriate place over the bottom grinder element 5, the first and second magnets 11 and 17 are aligned and preferably in contact with their poles arranged so that they attract each other when in close proximity. The attraction of the first and second magnets 11 and 17 releasably couples the top grinder element 4 and the bottom grinder element 5 during normal operation of the grinder 1. Preferably, the magnetic attraction of the first and second magnets 10 and 17 can be overcome with an intentional pulling apart of the bottom grinder element 5 and the top grinder element 4 by the user, when loading of the herbaceous material or cleaning of the grinder sector 2 is desired.

Using first and second magnets 11 and 17 to connect the top grinder element 4 and the bottom grinder element 5 is the preferred method for connecting the parts, but other methods could be used, such as a friction fit, a snap fit, interlocking formations on the parts, a threaded member, or a threaded connection of the parts. Methods of connecting the parts with fastening means that require the use of tools such as a screwdriver or wrench are also possible, but not preferred.

The top grinder element 4 is connected to the bottom grinder element 5 in a manner that allows the top grinder element 4 to be rotated with respect to the bottom grinder element 5. In use, the user holds the bottom grinder element 5 in one hand, stopping the bottom grinder element 5 from rotating, and using the flip-up handle 18 attached to the top grinder element 4, the operator uses their other hand to rotate the top grinder element 4 with respect to the bottom grinder element 5, preferably in a back and forth motion.

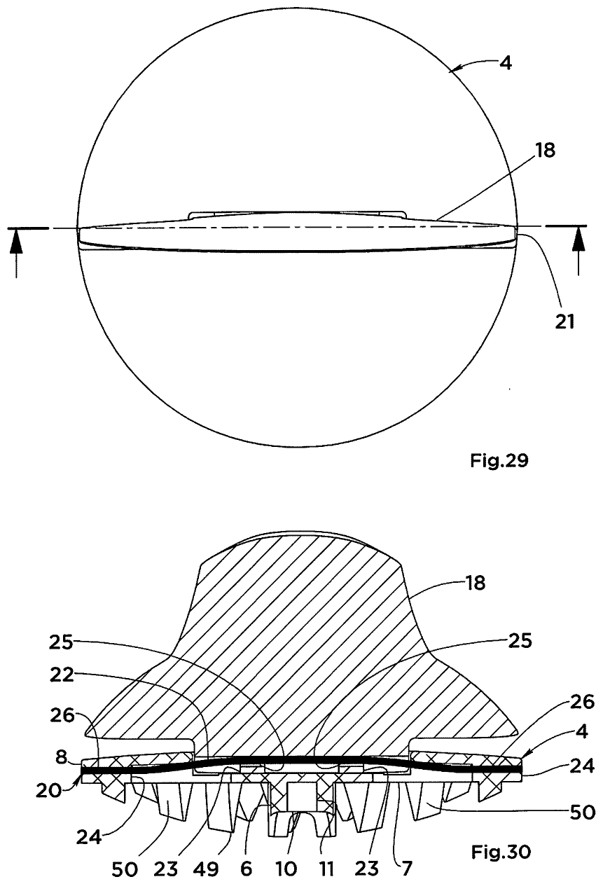

As shown in FIG. 30, the flip-up handle 18 of the top grinder element 4, preferably rotates upwardly from the upper surface 19 of the roof 8 of the top grinder element 4 on a hinge 20 located on a diameter 21 of the circular roof 8 of the top grinder element 4. The hinge 20 is preferably designed so that the flip-up handle 18 wants to either be disposed at an orthogonal angle to the generally flat roof 8 of the top grinder element 4 or disposed flat against the generally flat roof 8 of the top grinder element 4. The hinge 20 between the top grinder element 4 and the flip-up handle 18 is preferably made with a pin 22 made from spring steel. The flip-up handle knuckles 23 and roof knuckles 24 that hold the pin 22 are preferably offset such that when in used combination with the pin 22 made from spring steel, the spring action of the pin 22 pushes the flip-up handle 18 towards the orthogonally disposed, open position, or the flat, closed position against the upper surface 19 of the top grinder element 4. The flip-up handle 18 wants to snap into either a closed position with its main surface against the upper surface 19 of the top grinder element 4, or an open position where the flip-up handle 18 is disposed generally orthogonally to the generally flat upper surface 19 of the top grinder element 4.

The spring wire hinge pin 22 controls the motion of the flip-up handle 18 and temporarily holds the flip-up handle 18 in the open or closed positions. As shown in FIG. 30, the flip-up handle 18 where it receives the pin 22 has a cam form shape, such that when the flip-up handle 18 is rotated around the pin 22, the cam form shape or flip-up handle knuckles 23 push the pin bores 25 in the flip-up handle knuckles 23 eccentric to the mating pin bores 26 in the roof 8 of the top grinder element 4, thereby applying a bending moment to the spring wire hinge pin 22 which holds the flip-up handle 18 in the open position. When the flip-up handle 18 is in the closed position, the pin bores 25 and mating pin bores 26 are aligned and the spring wire hinge pin 22 is at rest and will resist movement from its rest position, helping the flip-up handle 18 remain in the closed position.

As shown in FIG. 32, the lower surface 27 of the floor 14 of the bottom grinder element 5 is formed with a depending spindle 28 at its center. The depending spindle 28 extends away from the lower surface 27 of the preferably non-flat floor 14. The depending spindle 28 has a blind bore 29 with an opening 30 at its lower end. In the preferred embodiment, and as shown, at least a portion of the blind bore 29 is internally threaded to receive the threaded screw 31 of the thumb screw assembly 32.

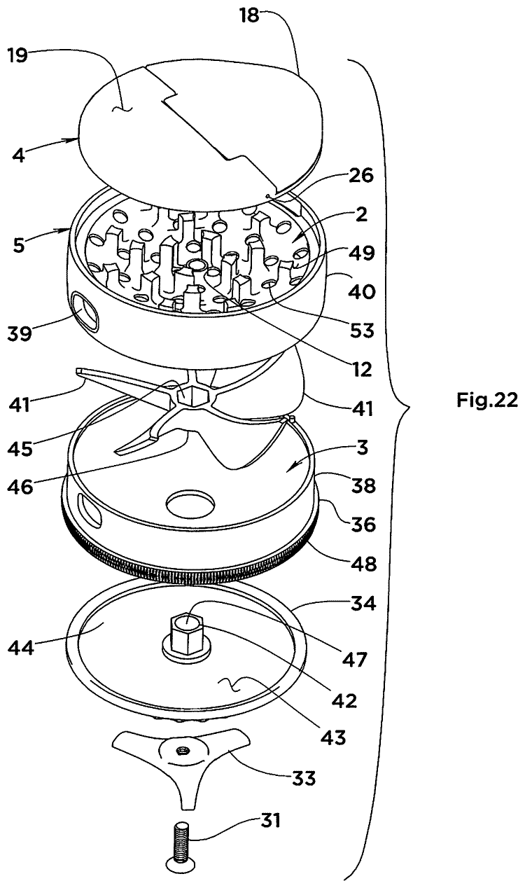

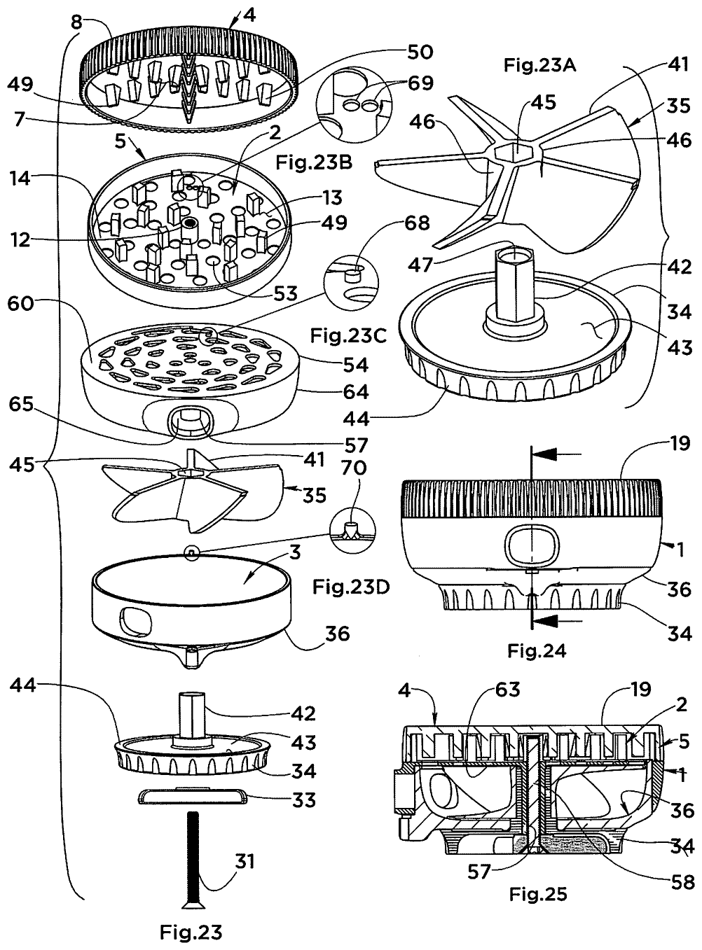

In the first preferred embodiment, and as shown best in FIGS. 23 and 25, the threaded screw 31 of the thumb screw assembly 32 is affixed to a lobed handle 33 by a locking pin (not shown), received by both members, so that rotation of the lobed handle 33 turns the threaded screw 31. Similarly sized openings, that can be aligned in the threaded screw 31 and the lobed handle 33, receive the locking pin.

The lobed handle 33 allows for the turning of the threaded screw 31 without a tool. Turning the threaded screw 31 in a first direction causes the screw to enter and engage with the depending spindle 28 of the bottom grinder element 5. When the threaded screw 31 is engaged with the depending spindle 28, the threaded screw 31 and the lobed handle 33 hold the wiper actuation member 34, the wiper or impeller 35 and the hopper member 36 between themselves and the bottom grinder element 5. Turning the thumb screw assembly 32 in the opposite direction to extract the threaded screw 31 from the depending spindle 28 while holding the bottom grinder element 5 such that it does not turn will allow the thumb screw assembly 32 to be removed from the depending spindle 28 and the disassembly of the hopper sector 3 for cleaning. Other methods of connecting the parts of the hopper section 3 without tools can also be used, such as by mechanical interlock of the parts or magnets, or other mechanisms. Other methods of connecting the parts of the hopper sector together with fastening mechanisms that require the use of tools such as a screwdriver or wrench can be used, but are not preferred.

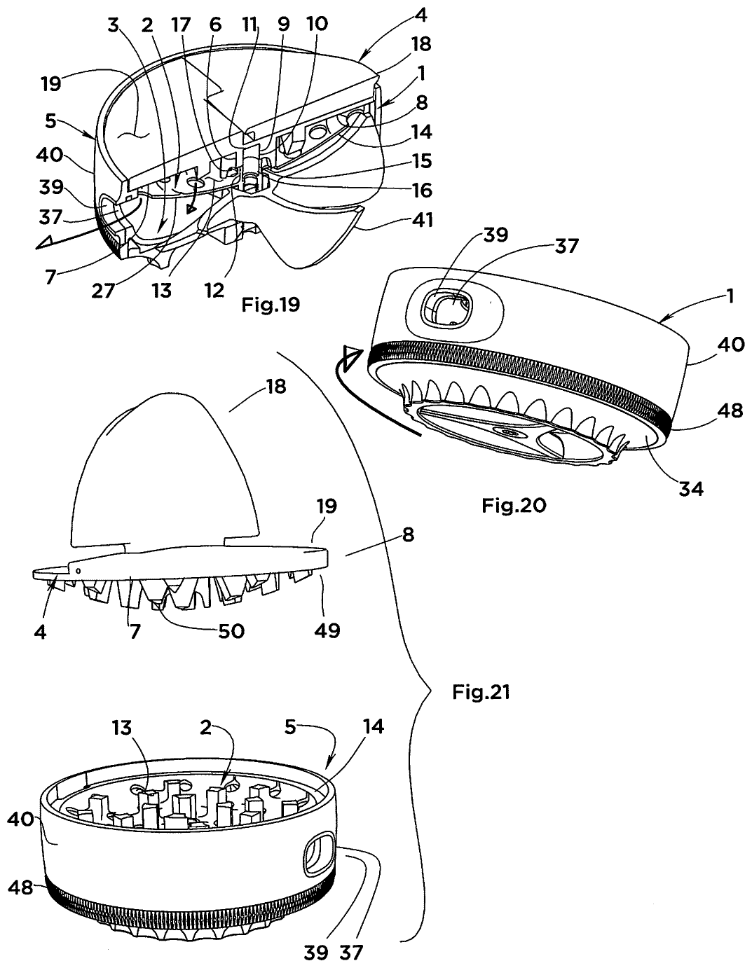

In the preferred embodiment, and as shown best in FIGS. 19 and 22, when the hopper sector 3 is assembled, the wiper actuation member 34 mechanically engages with the wiper 35, such that rotation of the wiper action member 34 in a given direction causes the rotation of the wiper 35 in the same direction. Rotation of the wiper actuation member 34 in a first direction causes the wiper 35 to turn which pushes the ground material to the circumferential edge of the hopper member 36 and out the dispensing port 37 in the peripheral sidewall 38 of the hopper member 36, when the side opening 39 in the depending peripheral wall 40 of the bottom grinder element 5 and the dispensing port 37 in the peripheral sidewall 38 of the hopper member 36 are aligned, or partially aligned. The wiper 35 is preferably formed with curved blades 41 that tend to push the ground material in the hopper sector 3 towards the circumferential edge of the hopper sector 3 when rotated in a particular direction.

As shown in FIG. 22, the wiper actuation member 34 is preferably formed with an upstanding post 42 that extends from an upper surface 43 of the base 44 of the wiper actuation member 34 at the center of the wiper actuation member 34. The upstanding post 42 extends through an opening in the hopper member 36. Preferably, the upstanding post 42 is formed with an outer surface that mechanically engages with an inner surface of a through opening 45 in the hub 46 of the wiper 35, such that when the wiper actuation member 34 is turned, the wiper 35 turns as well. As shown in FIG. 22, the outer surface of the upstanding post 42 of the wiper actuation member 34 can be formed as a hexagonal member that is received in a hexagonal-shaped opening 45 of the hub 46 of the wiper 35, but other shapes can be used to create the mechanical interlock.

The upstanding post 42 of the wiper actuation member 34 is also formed with a through bore 47 that has two open ends, one at its top and the other at its bottom. The upstanding post 42 closely receives the depending spindle 28 of the bottom grinder element 5 through its upper end and receives the threaded screw 31 of the thumb screw assembly 32 through its lower end. Preferably, the through bore 46 is cylindrical and can rotate without interference on the depending spindle 28. The through opening 45 in the wiper 35 also receives the depending spindle 28 of the bottom grinder element 5 through its upper end and the threaded screw of the thumb screw assembly through its lower end. The wiper 35 and the wiper actuation member 34 can both rotate around the depending spindle 28 of the bottom grinder element 5. The through bore 47 in the upstanding post 42 of the wiper actual member 34 is preferably a circular opening, creating a cylindrical through bore in the upstanding post 42, and the depending spindle 28 of the bottom grinder element 4 is preferably a cylindrical member that slidingly fits in the through bore 47 of the upstanding post 42 to allow for rotation of the wiper actuation member 34 and the wiper 3 with respect to the bottom grinder element 5 and the grinder sector 2.

The hopper member 36 is preferably formed with a port opening ring 48 that preferably consists of a roughened outer circumferential portion of the hopper member 36 so that that the hopper member 36 is easily gripped by the user and rotated in either direction to cause the alignment of the dispensing port 37 in the sidewall 38 of the hopper member 36 and the side opening 38 in the depending peripheral wall 40 of the bottom grinder element 5, such that the ground herbaceous material may be contained or released from the hopper sector 3.

Grinding or fragmenting herb into particles is largely achieved by trapping the herbaceous materials in between the top and bottom grinder elements 4 and 5 and rotating the top and bottom grinder elements 4 and 5 with respect to each other such that the bosses or projections 49 projecting therefrom in reciprocating arrangement slide past each other causing a shearing action on the herbaceous material. The grinding sector 2 is composed of two preferably circular elements: the top grinder element 4 and the bottom grinder element 5. The bosses 49 on each part are disposed in concentric arrangements with recesses or spaces between them that allow the bosses 49 to pass, and not hit each other when rotated.

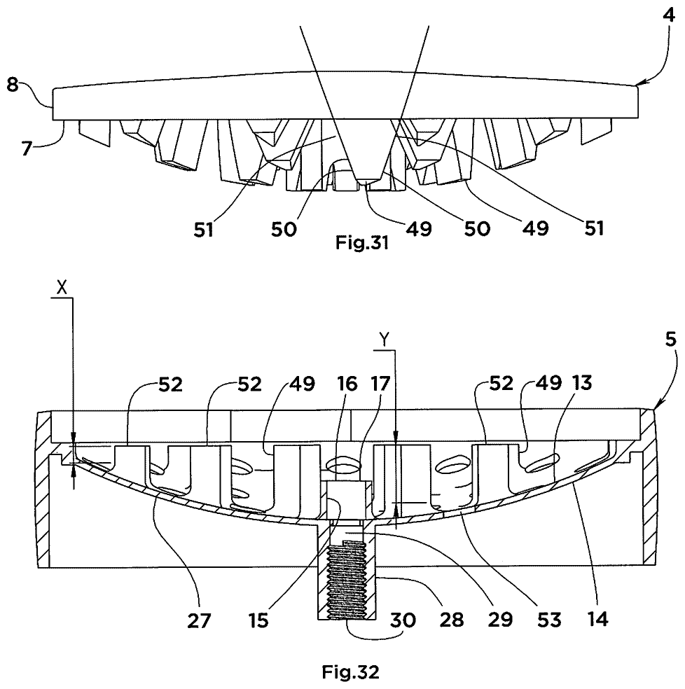

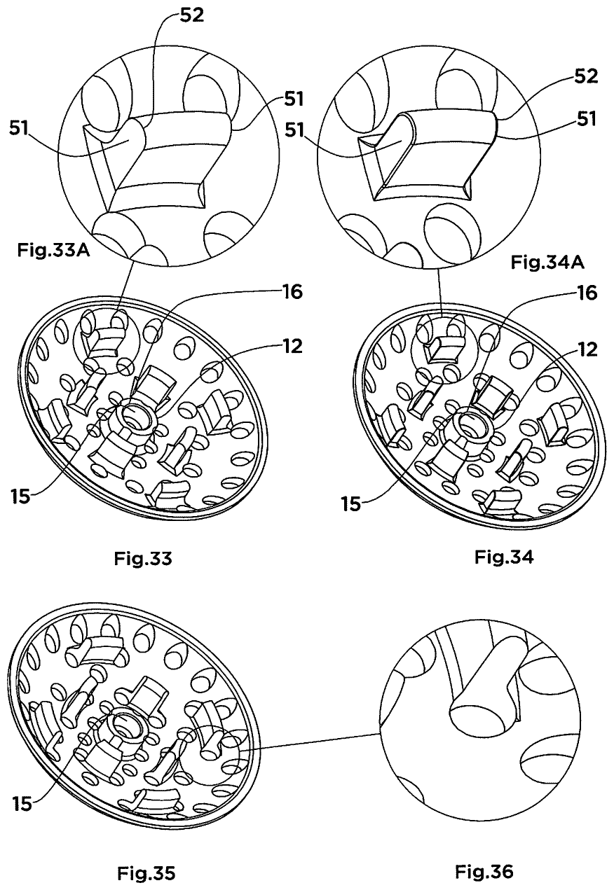

As shown in FIGS. 30 and 31, the bosses 49 on the top grinder element 4 are preferably made with opposed sloping pusher surfaces 50 that are disposed at obtuse angles to the lower surface 7 of the roof 8 of the top grinder element 4 such that the bosses 49 on the top grinder element 4 narrow as they extend away from the lower surface 7 of the roof 8. The opposed sloping pusher surfaces 50 are preferably located on the concentric ends 51 of the arced bosses 49 disposed in groups that are concentrically arranged on the top grinder element 4. The sloping pusher surfaces 50 push the herbaceous material to be ground against the concentrically arrayed bosses 49 projecting up from the upper surface 13 of the floor 14 of the bottom grinder element 5 to break down herbaceous materials into uniform smaller particles.

The bosses 49 on the top grinder element 4 extend downwardly from the lower surface 7 of the roof 8 of the top grinder element 4, and the bosses 49 on the bottom grinder element 5 extend upwardly from the preferably non-flat, upper surface 13 of the floor 14 of the bottom grinder element 5. In certain embodiments, the upper surface of 13 the floor 14 of the bottom grinder element 5 could be flat, although it would then require more force to grind the herbaceous materials.

The bottom grinder element 5 is preferably formed with a non-flat floor 14, or a bowl-shaped floor 14, or a rounded, conical floor 14. As shown in FIGS. 5 and 9, the bottom grinder element 5 is deepest near or at the center of the bottom grinder element 5, and the floor 14 extends upwardly, preferably in a curved manner to the periphery of the floor 14 of the bottom grinder element 5. The bottom grinder element 4 is formed with upstanding bosses 49 that extend upwardly from the preferably, non-flat floor 14. Preferably, all of the upstanding bosses 49 extend to a similar height. Preferably the top ends 52 of the upstanding bosses 49 extending from the upper surface 13 of the floor 14 of the bottom grinder element 5 extend very closely to the generally flat lower surface 7 of the roof 8 of the top grinder element 4, creating a uniform or nearly uniform gap between the top ends 52 of the upstanding bosses 49, and the lower surface 7 of the top grinder element 4.

The inventors note that other shapes of the floor 14 of the bottom grinder element 5 and the lower surface 7 of the roof 8 of the top grinder element 4 could be used to also achieve bosses 49 of varying heights along a radius of the top grinder element 4 and bottom grinder element 5.

The inventor believes having relatively shorter bosses 49 at the periphery of the rotating grinding surfaces compared to the relatively taller bosses 49 near the center of the rotating grinding surfaces to be innovative.

This innovation shortens the crushing bosses 49 at the outer portions of the top and bottom grinder elements 4 and 5 (see dimensional arrows X in FIG. 32) where the mechanical advantage is lowest and increases them closer to the center of the bottom grinder elements 5 (see dimensional arrows Y in FIG. 32) where the mechanical advantage is greatest. This lowers the input forces required to break the herbaceous material into smaller pieces.

Many patents describe knife or cutting edges on the bosses 49 that act on the flower buds or herbaceous materials. How these edges are manufactured becomes a challenge particularly if the heights of the bosses 49 is varied as described above. As shown in FIGS. 35 and 36, one solution is to create the cutting edge by machining from the underside of the bottom grinder element 5, then along the length of the boss 49, creating a cutting edge.

While the preferred embodiment does not have bosses 49 with sharpened edges, to create a sharper cutting edge at the intersection of two sides of a boss 49 on the bottom grinder element 5, the two sides of the boss 49 that meet at the shared edge preferably approach their shared edge with portions that are disposed at angle of less than 90 degrees, and there is no rounding of the edge where the two sides meet. This can be achieved by forming the bosses 49 with concave side surfaces that meet at sharp edges. Concave side edges can be formed in the bosses 49 and by machining the bosses 49 with a cutting drill. The same drill to machine the side edges of the bosses 49 can be used to cut the filter holes 53 in the non-flat floor 14 of the bottom grinder element 5. The drill is preferably run upward through the lower surface 27 of the bottom grinder element 5 to cut a filter hole 53 in the non-flat floor 14, and then is used to cut concave formations in the sides of the bosses 49 as shown in FIGS. 35 and 36. The ground herbaceous material when it is ground to a size small enough to pass through the filter holes 53 will drop into the hopper sector 3.

In the preferred embodiment the inventors have formed the bosses 49 without sharp cutting edges. The inventors have found that most of the fragmenting work is a combination of tearing and crushing, rather than just cutting. The dull edges are an advantage in manufacturing too as they can be formed without the need for additional machining.

As shown in FIGS. 19, 21 and 22, the bottom grinder element 5 is formed with a circular, upstanding peripheral wall 70, and the top grinder element 4 is formed with a circular, mating peripheral wall that 71 that is constrained by and slides along peripheral wall 70 when the top and bottom grinder elements 4 and 5 are connected and rotated with respect to each other. This arrangement could be reversed such that the bottom grinder element 5 is received in the top grinder element 4 as shown in FIGS. 23, 24 and 25.

The particle size of the ground herbaceous material is largely determined by the gaps between the bosses 49 and the size of the passages through which the ground material travels from the grinder sector 2 to the hopper sector 3.

An alternate embodiment of the grinder 1 of the present invention is shown in FIGS. 23-28. As in the embodiment described above, the grinder sector 2 and the hopper sector 3 are separated, but the bottom grinder element 5 is modified, and a filtration member 54 is included. The addition of the filtration member 54 allows for the change in the size of the passages through which the ground herbaceous material passes from the grinding sector 2 to the hopper sector 3.

In the embodiment of the invention shown in FIGS. 23-28, the bottom grinder element 5 is modified so that it does not have a depending spindle 28 and it does not have a depending peripheral wall 40. The bottom grinder element 5 is formed with an upstanding projection 12 that has a through bore 55 and an internal threaded portion. The top grinder element 4 engages the bottom grinder element 5 with snap-fit mechanisms on the peripheral walls of the top and bottom grinder elements 4 and 5 to releasably attach the top grinder element 4 to the bottom grinder element. The filtration member has an opening 56 at its center. The filtration member 54 has a descending spindle 57 that has a through bore 58.

As shown in FIG. 23, the filtration member 54 is formed with a diaphragm 60 that has an upper surface 61 that corresponds to the shape and contour of the lower surface 27 of the floor 14 of the bottom grinder element 5. The upper surface 61 of the diaphragm 60 interfaces closely with the lower surface 27 of the floor 14 of the bottom grinder element 5. The diaphragm 60 is formed with matching filtration holes 62. The diaphragm 60 of the filtration member 54 is formed with the descending spindle 57 at its center. The descending spindle 57 extends away from the lower surface 63 of the diaphragm 60. The through bore 58 receives the threaded screw 31 of the thumb screw assembly 32, and the descending spindle 57 is able to rotate on the threaded screw 31. The threaded screw 31 passes through the descending spindle 57, the opening 56 and threadably engages the threaded portion of the upstanding projection 12 of the bottom grinder element 5 to sandwich the filtration member 54 the hopper member 36 between the bottom grinder element 5 and the thumb screw assembly 32.

As described above with respect to the first embodiment of the grinder 1, in the embodiment of the grinder 1 show in FIGS. 23-28, the hopper member 36 is formed with a dispensing port 37 in the peripheral sidewall 38 of the hopper member 36. However, it is the filtration member 54 that is formed with a depending peripheral wall 64 with a side opening 65. When the dispensing port 37 in the peripheral sidewall 38 of the hopper member 36 is aligned with side opening 65 in the depending peripheral wall 64, or partially aligned, ground herbaceous material can be dispensed from the hopper sector 3. The wiper 35 is preferably formed with curved blades 41 that generally push the ground material in the hopper sector 3 towards the circumferential edge of the hopper sector 3 when rotated in a particular direction. Typically, the user will rotate the wiper 35 back and forth in both a clockwise and a counter-clockwise manner to push the material out of the grinder 1.

As described above with respect to the first embodiment of the grinder 1, the upstanding post 42 of the wiper actuation member 34 is also formed with a through bore 47 that has two open ends, one at its top and the other at its bottom. The upstanding post 42 closely receives the descending spindle 57 of the filtration member 54 through its upper end and receives the threaded screw 31 of the thumb screw assembly 32 through its lower end. Preferably, the through bore 46 is cylindrical and can rotate without interference on the descending spindle 57. The through opening 45 in the wiper 35 also receives the descending spindle 57 of the filtration member 54 through its upper end and the threaded screw 31 of the thumb screw assembly 32 through its lower end. The wiper 35 and the wiper actuation member 34 can both rotate around the descending spindle 57 of the filtration member 54. The through bore 47 in the upstanding post 42 of the wiper actual member 34 is preferably a circular opening, creating a cylindrical through bore in the upstanding post 42, and the descending spindle 57 of the filtration member 44 is preferably a cylindrical member that slidingly fits in the through bore 47 of the upstanding post 42 to allow for rotation of the wiper actuation member 34 and the wiper 35 with respect to the filtration member 54 and the grinder sector 2. The upstanding post 42 of the wiper actuation member 34 mechanically interlocks with the through opening 45 in the wiper 35, so that when the wiper actuation member 34 is turned the wiper 35 is turned.

As shown in FIG. 23, the matching filtration holes 62 of the filtration member 54 are formed as elongated holes that widen from a narrow end 66 to an enlarged end 67. The elongated matching filtration holes 62 are long enough that depending on which portion of the filtration holes 62 are aligned with the filter holes 53 in the floor 14 of the bottom grinder element 5, the size of the passage through which ground herbaceous materials can pass from the grinder sector 2 to the hopper sector 3 will be different.

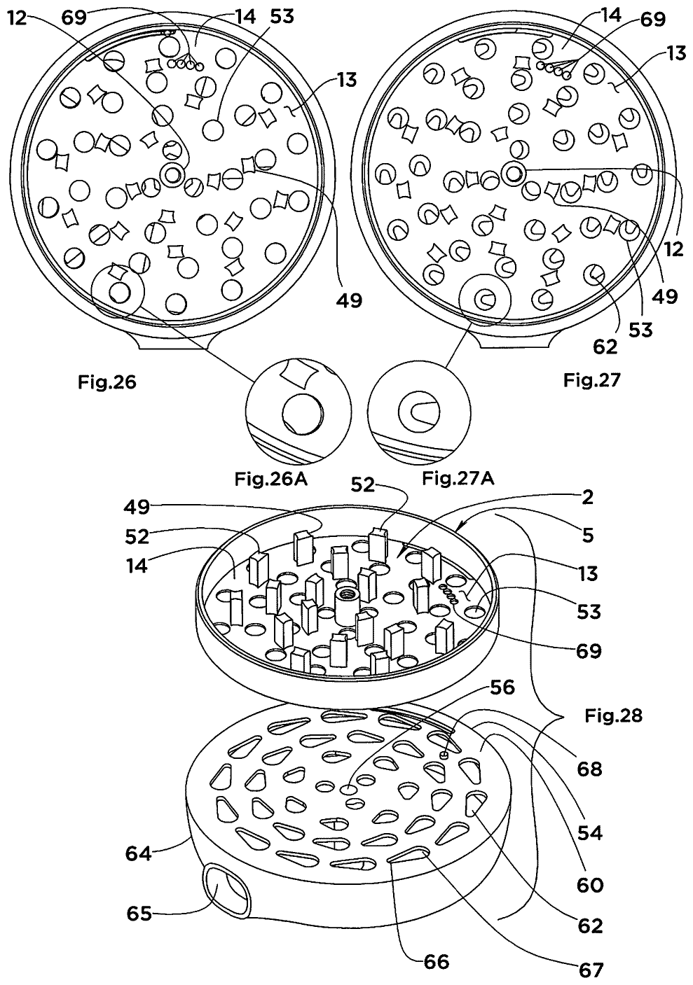

The filtration member 54 and the bottom grinder element 5 can have mechanisms for setting the rotational orientation of the filtration member 54 with the bottom grinder element 5 to align the filter holes 53 with the matching filtration holes 62 at a particular point along the elongated matching filtration holes 62. As shown in FIG. 23, the upper surface 61 of the diaphragm 60 has a upstanding pin 68 that can be received in a number of different indexing openings 69 in the floor 14 of the bottom grinder element 5 that are sized to closely receive the pin 68. Depending on which indexing opening 69 receives the pin 68, the size of the passage for transferring ground materials from the grinder sector 2 to the hopper sector 3 will change. As shown in FIG. 26, the floor 14 of the grinder element can be made with four indexing openings 69. FIGS. 26 and 26A show the arrangement when the enlarged ends 67 of the matching filtration holes 62 are aligned with the filter holes 53. FIGS. 27 and 27A show the arrangement with the narrow ends 66 of the matching filtration holes 62 are aligned with the filter holes 53.

As shown in FIGS. 23 and 23D the hopper member 36 can be made with a indexing pin 70 that engages with a short track on the filtration member 54 to limit the rotational orientations of the hopper member 36 and filtration member 54 so that the dispensing port 37 and the side opening 65 remain in close proximity or alignment.

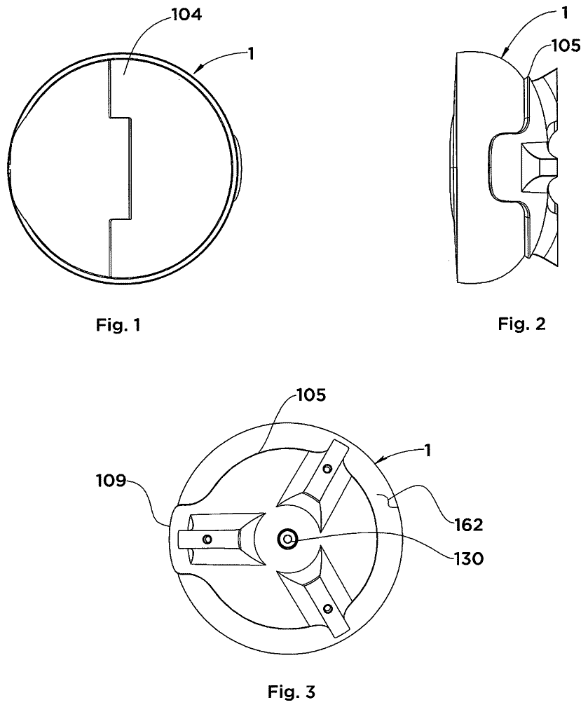

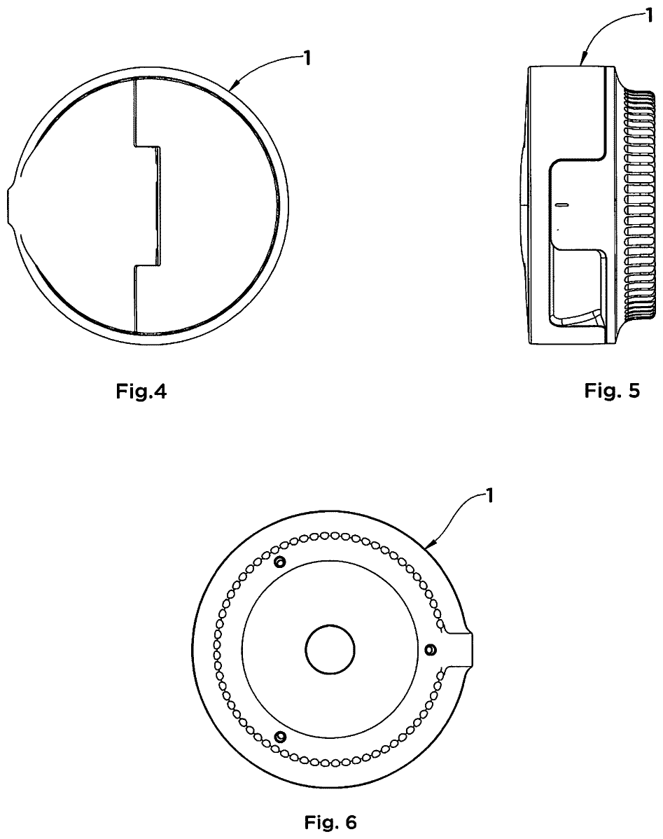

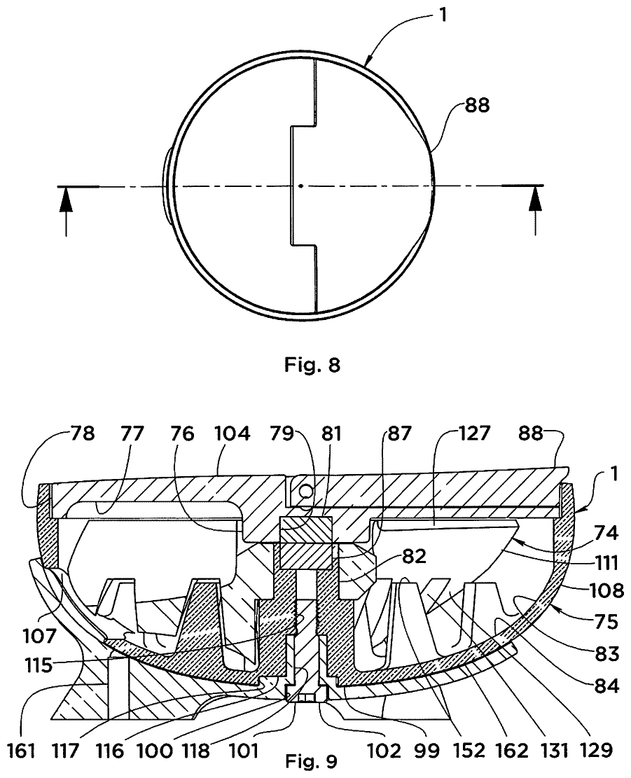

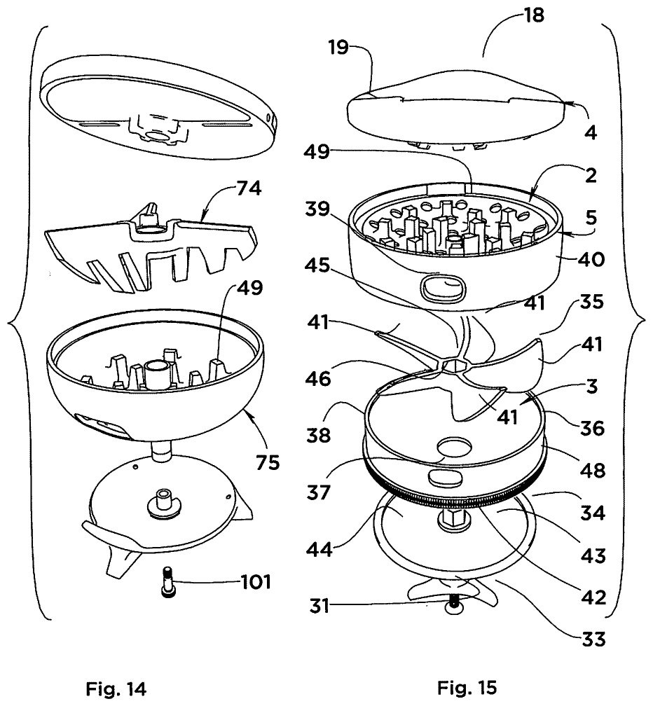

As shown in FIGS. 1-3, and 7-15, in another embodiment of a grinder 1 of the present invention, there is no separate hopper sector. The grinder 1 is formed with a combined grinder and wiper element 74 and a bottom grinder element 75. The combined grinder and wiper element 74 and the bottom grinder element 75 are preferably formed from metal, but they can also be formed from other moldable materials such as plastic. The combined grinder and wiper element 74 and the bottom grinder element 75 are preferably formed so that the bottom grinder element 75 can receive and be coupled to the combined grinder and wiper element 74 in a manner that allows for rotation of the combined grinder and wiper element 74 with respect to the bottom grinder element 75 when the parts are assembled together. The combined grinder and wiper element 74 and the bottom grinder element 75 are preferably able to be joined together in a manner that allows for their assembly and dis-assembly without the use of tools. The combined grinder and wiper element 74 works in combination with a top wiper actuation member 104.

The top wiper actuation member 104 is preferably formed with a dependent projection 76 at its center. The dependent projection 76 extends from the lower surface 77 of roof 78 of the top wiper actuation member 104, preferably at the center of the top wiper actuation member 104. The dependent projection 76 of the top wiper actuation member 104 is formed with a blind bore 79 with an opening 80 at the lower end of the dependent projection 76. The dependent projection 76 preferably receives and holds a fifth magnet 81 in the opening 80 in the lower end of the dependent projection 76. The fifth magnet 81 can be glued into the opening 80 or held by friction or other mechanical means.

The bottom grinder element 75 is preferably formed with an upstanding projection 82 at its center. The upstanding projection 82 extends from the upper surface 83 of the preferably non-flat floor 84 of the bottom grinder element 75, preferably at the center of the bottom grinder element 75. The upstanding projection 82 of the bottom grinder element 75 is formed with a through bore 85 with an opening 86 at the upper end of the upstanding projection 82. The opening 86 at the upper end of the through bore 85 in the upstanding projection 82 preferably receives and holds a sixth magnet 87 in place. When the top wiper actuation member 104 is set in the appropriate place over the bottom grinder element 75, the fifth and sixth magnets 81 and 87 are aligned and preferably in contact with their poles arranged so that they attract each other when in close proximity. The attraction of the fifth and sixth magnets 81 and 87 releasably couples the top wiper actuation member 104 and the bottom grinder element 75 during normal operation of the grinder 1. Preferably, the magnetic attraction of the fifth and sixth magnets 81 and 87 can be overcome with an intentional pulling apart of the bottom grinder element 75 and the top wiper actuation member 104 by the user, when loading of the herbaceous material or cleaning of the grinder 1 is desired.

Using fifth and sixth magnets 81 and 87 to connect the top wiper actuation member 104 and the bottom grinder element 75 is the preferred method for connecting the parts, but other methods could be used, such as a friction fit, a snap fit, interlocking formations on the parts, or a threaded connection of the parts. Methods of connecting the parts with fastening means that require the use of tools such as a screwdriver or wrench are also possible, but not preferred.

The top wiper actuation member 104 is connected to the bottom grinder element 75 in a manner that allows the top wiper actuation member 104 to be rotated with respect to the bottom grinder element 75. In use, the user holds the bottom grinder element 75 in one hand, stopping the bottom grinder element 75 from rotating, and using the flip-up handle 88 attached to the top wiper actuation member 104, the operator uses their other hand to rotate the top wiper actuation member 104 with respect to the bottom grinder element 75.

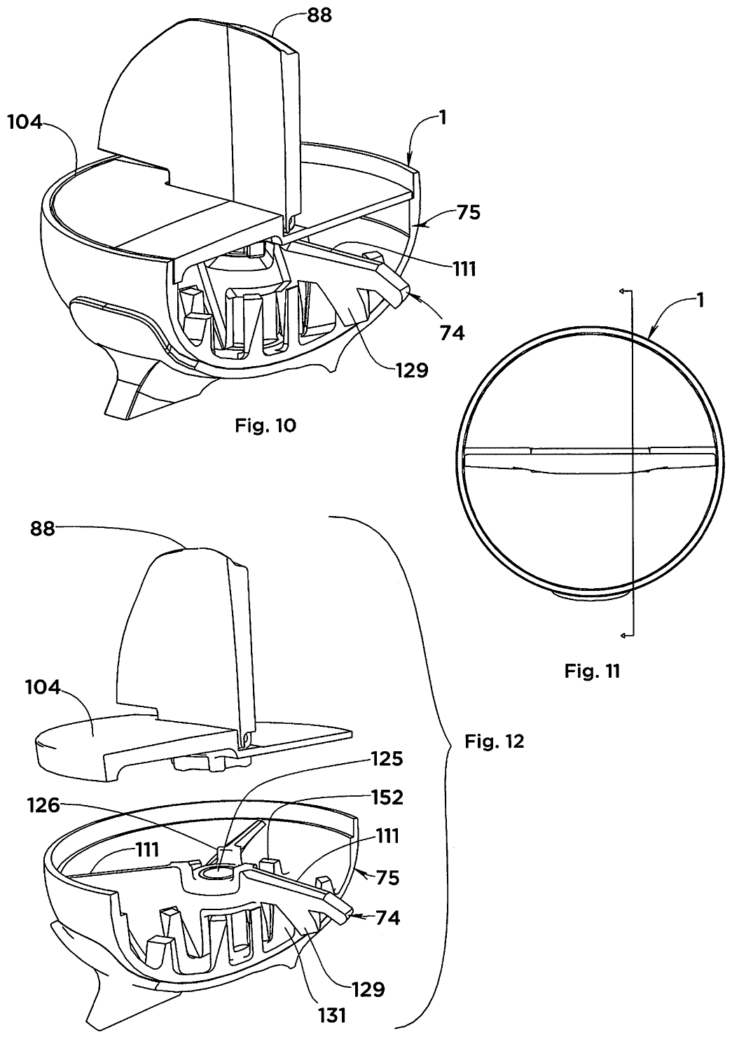

As shown in FIGS. 10-13, the flip-up handle 88 of the top wiper actuation member 104 operates in a similar fashion as the flip-up handle 18 for the top grinder element 4 of the first embodiment described.

The upstanding projection 82 of the bottom grinder element 75 has a through bore 85 with an opening 100 at its lower end. In the preferred embodiment, and as shown, at least a portion of the through bore 85 is internally threaded to receive the threaded screw 101 of the thumb screw assembly 102.

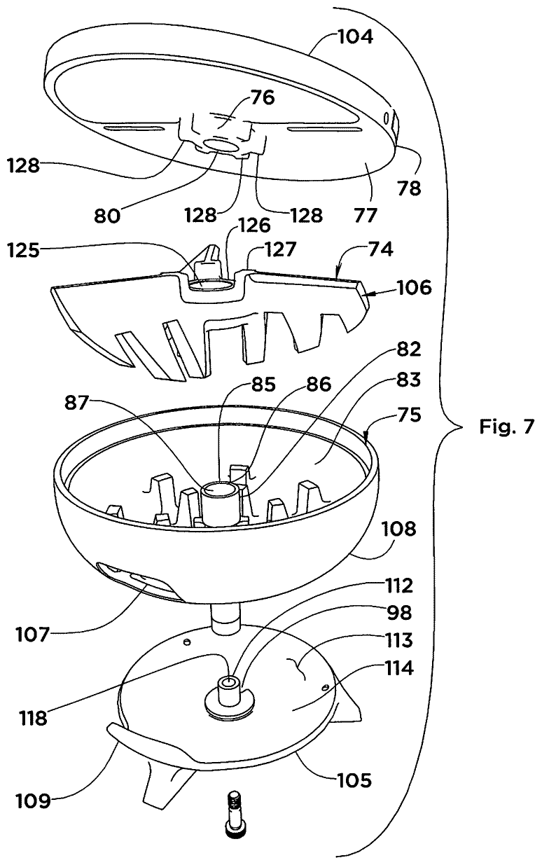

In the preferred embodiment, and as shown best in FIGS. 7 and 9, the threaded screw 101 of the thumb screw assembly 102 is affixed to a lobed handle 103 by a locking pin (not shown), received by both members, so that rotation of the lobed handle 103 turns the threaded screw 101. Similarly sized openings, that can be aligned in the threaded screw 101 and the lobed handle 103, receive the locking pin.

The lobed handle 103 allows for the turning of the threaded screw 101 without a tool. Turning the threaded screw 101 in a first direction causes the threaded screw 101 to enter and engage with the upstanding projection 82 of the bottom grinder element 75. When the threaded screw 101 is engaged with the upstanding projection 82, the threaded screw 101 and the lobed handle 103 hold the port cover member 105 between themselves and the bottom grinder element 75. Turning the thumb screw assembly 102 in the opposite direction to extract the threaded screw 101 from the upstanding projection 82 while holding the bottom grinder element 75 such that it does not turn will allow the thumb screw assembly 102 to be removed from the upstanding projection 82 and the disassembly of the grinder 1 for cleaning. Other methods of connecting the parts of the grinder 1 without tools can also be used, such as by mechanical interlock of the parts or magnets, or other mechanisms. Other methods of connecting the parts of the grinder 1 together with fastening mechanisms that require the use of tools such as a screwdriver or wrench can be used, but are not preferred.

As shown in FIG. 7, the grinder 1 of this particular embodiment also has a combined grinder and wiper 74. In the preferred embodiment, and as shown best in FIGS. 7 and 9, when the grinder 1 is assembled, the top wiper actuation member 104 mechanically engages with the combined grinder and wiper 74, such that rotation of the top wiper action member 104 in a given direction causes the rotation of the combined grinder and wiper 74 in the same direction. Rotation of the top wiper actuation member 104 causes the combined grinder and wiper 74 to turn which can push the ground material to the circumferential edge of the grinder 1 and out the dispensing port 107 in the peripheral sidewall 108 of the bottom grinder element 75, when the cover flange 109 of the port cover member 105 and the dispensing port 107 in the peripheral sidewall 108 of the bottom grinder element 75 are not aligned, or only partially aligned.

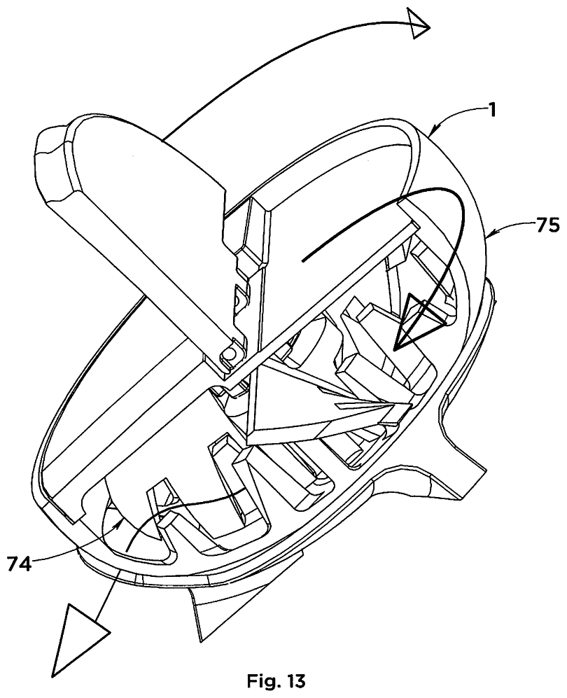

As shown in FIGS. 12 and 13, the combined grinder and wiper 74 is preferably formed with the lower portions of the blades 111 being slightly curved or skewed. The curved lower portions of the blades 111 are curved along a radius from the axis of rotation 130 to the periphery of the grinder 1. The blades 111 are also preferably angled with respect to the axis of rotation 130 at a non-orthogonal angle such that the lower portions of the blades 111 are not directly underneath the top portions of the blades 111. The angle of the blades 11a can change on a gradient along the blades 111.

As shown in FIG. 7, the port cover member 105 is preferably formed with an upstanding post 112 that extends from an upper surface 113 of the base 114 of the post cover member 105 at the center of the post cover member 105. The upstanding post 112 extends into a middle-lower portion 115 of the through bore 85 of the upstanding projection 82 of the bottom grinder element 75. Preferably, the lower portion 116 of the upstanding post 112 is formed with an outer surface that mechanically engages with an inner surface of the lower portion 117 of the through bore 85 of upstanding projection 82 of the bottom grinder element 75, such that the post cover member 105 can only be turned a limited amount with respect to the upstanding post 112. As best shown in FIGS. 7 and 9, the outer surface of the lower portion 116 of the upstanding post is formed with a notch 98 and a portion of the inner surface of the lower portion 117 of the through bore as an extension 99 that fits into the notch and can travel circumferentially in the notch 98 to allow limited rotational movement of the post cover member 105 with respect to the bottom grinder element 75.

The upstanding post 112 of the port cover member 105 is also formed with a through bore 118 that has two open ends, one at its top and the other at its bottom. The upstanding post 112 closely receives the threaded screw 101 of the thumb screw assembly 102 through its lower end. Preferably, the through bore 118 of the upstanding post 112 has a cylindrical portion and can rotate without interference on a cylindrical, unthreaded portion of the threaded screw 101.

As shown in FIG. 7, the top wiper actuation member 104 is preferably formed with a dependent projection 76 that extends from the lower surface 77 of the roof 78 of the top wiper actuation member 104 at the center of the top wiper actuation member 104. The dependent projection 76 extends into a through opening 125 in a hub 126 in the combined grinder and wiper 74. Preferably, the dependent projection 76 is formed with an outer surface that mechanically engages with the upper portion 127 of the combined grinder and wiper 74, such that when the top wiper actuation member 104 is turned, the combined grinder and wiper 74 turns as well. As shown in FIG. 7, the outer surface of the dependent projection 76 of the top wiper actuation member 104 can be formed with radial spokes 128 that receive between them the inner portions of the blades 111 of the combined grinder and wiper 74.

Grinding or fragmenting herb into particles is largely achieved by trapping the herbaceous materials in between the combined grinder and wiper 74 and the bottom grinder element 75 as the combined grinder and wiper 74 and the bottom grinder element 75 are rotated with respect to each other such that the bosses or projections 49 projecting from the floor 84 of the bottom grinder element 75 in reciprocating arrangement, slide past spaced swiping members 129 on the blades 111, causing a shearing action on the herbaceous material. The swiping members 129 are spaced apart from each other by recesses 131 that are shaped to allow the combined grinder and wiper 74 to extend closely to the upper surface 83 of the floor 84 of the bottom grinder element 75 without interference from the bosses 49 when the combined grinder and wiper 74 is rotated with respect to the bottom grinder element 75. The bosses 49 and the swiping members 129 are disposed in concentric arrangements that allow the bosses 49 and the swiping members 129 to pass, and not hit each other when rotated with respect to each other.

As shown in FIGS. 7 and 9, the blades 111 and the swiping members 129 are preferably made with sloping surfaces. The blades 111 are all sloped and angled in a similar manner such that when the combined grinder and wiper 74 is turned in a first direction, the upper portions of the blades 111 leads most of the portions of the swiping members 129 which constitute the lower portions of the blades 111. Conversely, when the combined grinder and wiper 74 is turned in a second direction, the upper portions of the blades 111 trail most of the portions of the swiping members 129 which constitute the lower portions of the blades 111. In this manner, when the combined grinder and wiper 74 is rotated in one direction, the herbaceous material is pushed downwardly against the bosses 49. The swiping members 129 push the herbaceous material to be ground against the concentrically arrayed bosses 49 projecting up from the upper surface 113 of the floor 114 of the bottom grinder element 75 to break down herbaceous materials into uniform smaller particles. When the combined grinder and wiper is rotated in the opposite direction, the herbaceous material is pushed upwardly so that it may more easily pass through the dispensing port 107 in the peripheral sidewall 108, and so that the herbaceous material can be turned and rotated. The wiper 35 of other preferred embodiments is formed in a similar manner.

As shown in FIGS. 7 and 9, the blades 111 and the swiping members 129 are preferably made with curved or skewed surfaces along their radial extensions. The blades 111 are all curved or skewed in a similar manner such that when the combined grinder and wiper 74 is turned in a first direction, lower portions of the inner portions of the blades 111 lead the lower portions of the outer portions of the blades 111. Conversely, when the combined grinder and wiper 74 is turned in a second direction, the lower portions of the outer portions of the blades 111 lead the lower portions of the inner portions of the blades 111. In this manner, when the combined grinder and wiper 74 is rotated in the first direction, the herbaceous material is more inclined to be pushed outwardly with respect to the axis of rotation 130 so that it may pass through the dispensing port 107 in the peripheral sidewall 108. When the combined grinder and wiper is rotated in the opposite direction, the blades 111 and swiping members 129 tend to push the herbaceous material to be ground inwardly towards the axis of rotation 130 against the concentrically arrayed bosses 49 projecting up from the upper surface 113 of the floor 114 of the bottom grinder element 75 to break down herbaceous materials into uniform smaller particles. The wiper 35 of other preferred embodiments is formed in a similar manner.

The bosses 49 on the bottom grinder element 75 extend upwardly from the preferably non-flat, upper surface 83 of the floor 84 of the bottom grinder element 75. In certain embodiments, the upper surface of 83 the floor 84 of the bottom grinder element 75 could be flat, although it would then require more force to grind the herbaceous materials.

The bottom grinder element 75 is preferably formed with a non-flat floor 84, or a bowl-shaped floor 84, or a rounded, conical floor 84. As shown in FIG. 9, the bottom grinder element 75 is deepest near or at the center of the bottom grinder element 75, and the floor 84 extends upwardly, preferably in a curved manner to the periphery of the floor 84 of the bottom grinder element 75. The bottom grinder element 75 is formed with upstanding bosses 49 that extend upwardly from the preferably, non-flat floor 84. Preferably, all of the upstanding bosses 49 extend to a similar height. Preferably the top ends 152 of the upstanding bosses 49 extending from the upper surface 83 of the floor 84 of the bottom grinder element 75 extend about half the height of the bottom grinder element 75, creating a uniform or nearly uniform gap between the top ends 152 of the upstanding bosses 49, and the lower surface 77 of the roof 78 of the top wiper actuation member 104.

The bosses 49 at the outer portions of the bottom grinder element 75 are relatively shorter than the bosses 49 located at portions closer to the center of the bottom grinder element 75.

As shown in FIGS. 3, 7 and 9, the port cover member 105 can be formed with spring pins 161 that engage with indentations in the lower surface 162 of the floor 84 of the bottom grinder element 75 to resist movement of the cover flange 109 from being disposed in sealing relation to the dispensing port 107 in the peripheral side wall 108 of the bottom grinder element 75. By providing a twisting force to port cover member 105 the user can overcome the resisting force of the spring pins 161 and move the cover flange 109 away from the dispensing port 107.

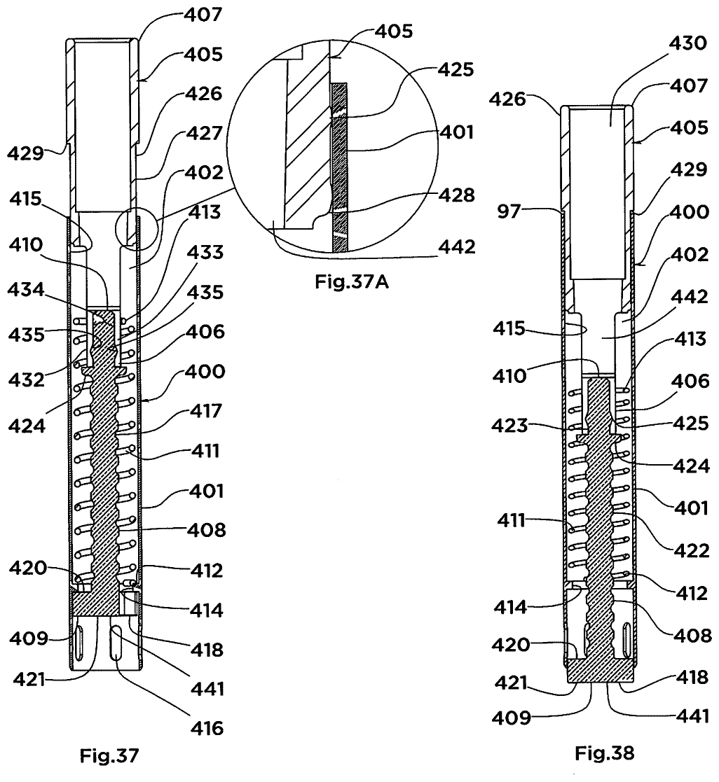

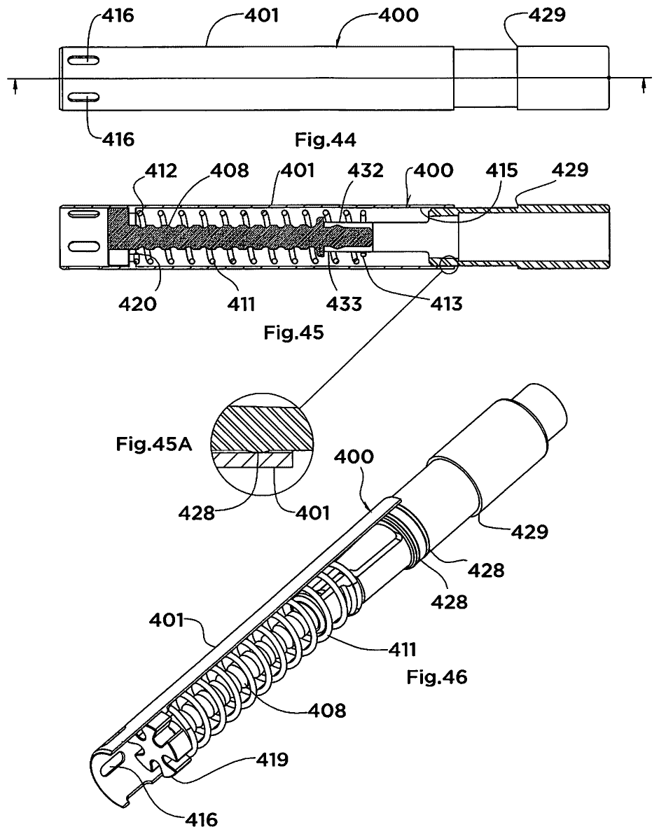

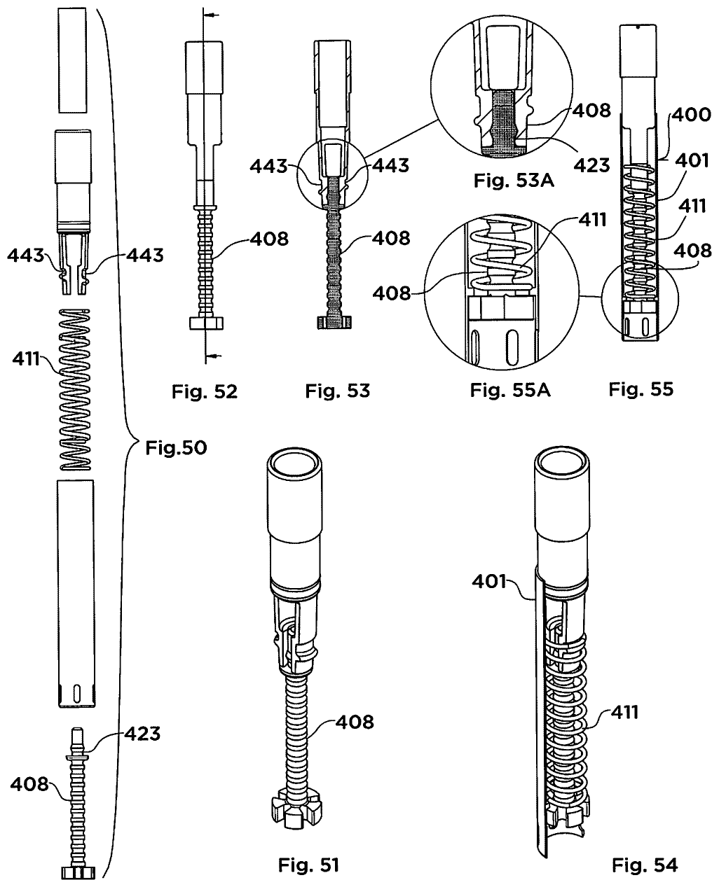

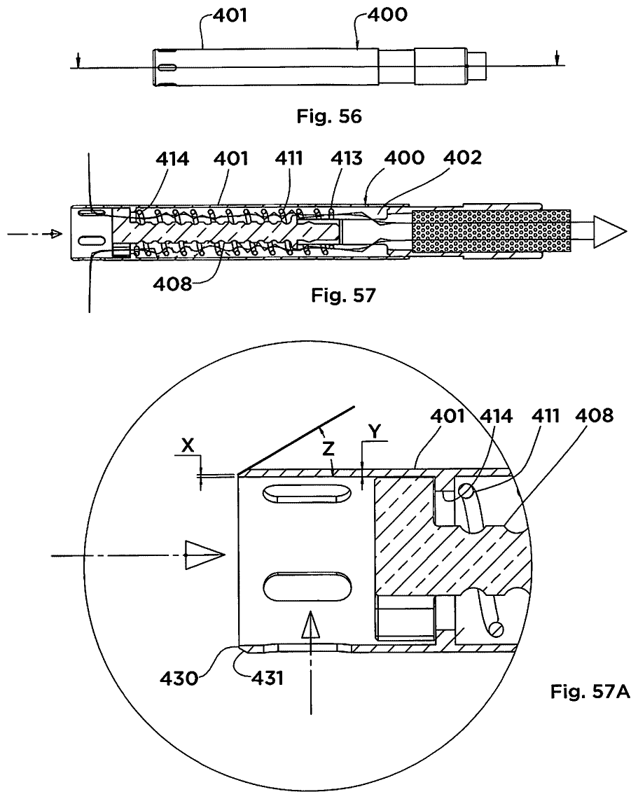

As shown in FIGS. 37-38 and 44-57A, the present invention also includes a single dose smoking device 400. The smoking device 400 includes a tubular body 401, having a continuous longitudinal recess 402 that extends the length of the tubular body 401. The tubular body 401 has an inlet end 403 and an outlet end 404. The smoking device also has a mouthpiece 405 with an internal air passage, having a front end 406 and rear end 407 with the front end 406 connecting to the outlet end 404 of the tubular body 401. The mouthpiece 405 connects to plunger 408 that has a front end 409 and a rear end 410 with the mouthpiece connecting to the rear end 410 of the plunger 408. The smoking device 400 also has an ejection spring 411 that has a front end 412 and a rear end 413. The ejection spring 411 is contained in the tubular body 401 with the rear end 413 of the ejection spring being connected to or in abbutting relation with the front end 406 of the mouthpiece 405. The front end 412 of the ejection spring 411 bears upon an inner shoulder 414 of the tubular body 401 near the inlet end 403 of the tubular body 401.

The tubular body 401 can have a generally smooth inner surface 415. The tubular body 401 also has an inner shoulder 414 that extends radially inwardly from the inner surface 415 of the tubular body 401. The tubular body 401 also has a plurality of openings 416 formed near the inlet end 403. The openings 416 are preferably elongated along the length of the tubular body 401.

The plunger 408 is formed as an elongated member with an elongated shaft 417 that extends between the front end 409 and the rear end 410 of the plunger 408. The front end 409 of the plunger 408 is formed with a flaring head 418. The flaring head 418 consists of a plurality of radial spokes 419 extending from the shaft 417. The flaring head 418 has a rear bearing surface 420 that bears against the front edge 421 of the inner shoulder 415 of the tubular body 401 when the components of the smoking device 400 are connected to each other and the ejection spring 411 is not extended or compressed, but rather in a rest position. The flaring head 418 is shaped so that smoke from burning herbaceous materials at the inlet end 403 of the tubular body 410 can pass between portions of the radial spokes 419 near the axis of the plunger 408 and around the inner shoulder 415 of the tubular body 401 and travel to the outlet end 404 of the tubular body.

The elongated shaft 417 of the plunger 408 preferably has an outer surface 422 that is not smooth, but rather has a combination of ridges and indentations or convulutions.

As shown in FIGS. 37 and 38, the rear end 410 of the plunger 408 is preferably formed with an annular seat 423 bracketed by a forward annular extension 424 and a rearward annular extension 425. Preferably the forward annular extension 424 extends closer to the inner surface 415 of the tubular body 401 than the rearward annular extension 425. The annular seat 423 makes a snap-fit connection with the mouthpiece 405.

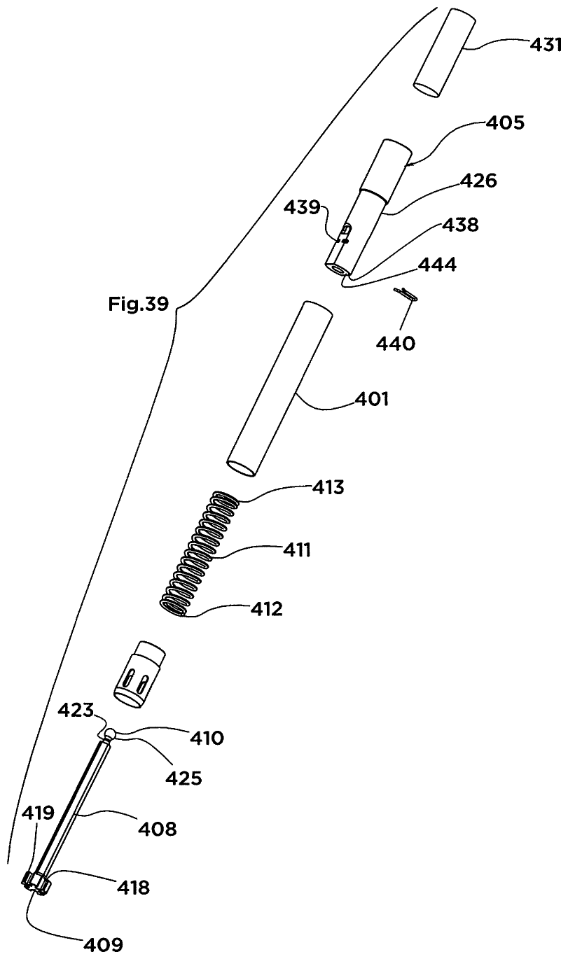

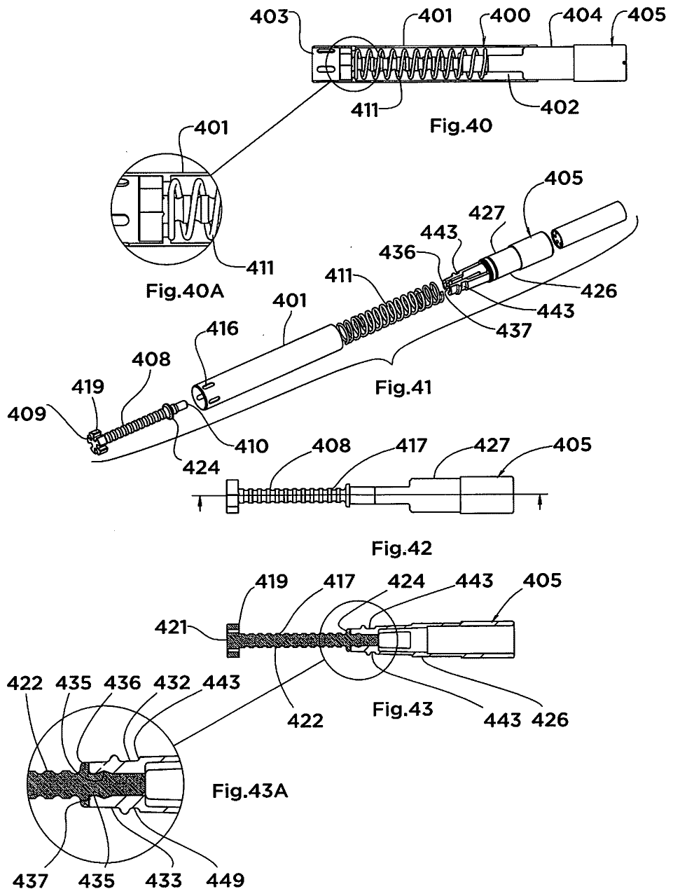

As shown in FIGS. 39 and 41, the mouthpiece 405 is removably connected to the rear end 410 of the plunger 408 and is removably connected to the outlet end 404 of the tubular body 401. The mouthpiece 405 has a generally cylindrical rear portion 426 and a narrowed front portion 427. When the smoking device is assembled and the ejection spring 411 is at rest, the narrow front portion 427 is received within the outlet end 404 of the tubular body 401, and most of the generally cylindrical rear portion 426 of the mouthpiece 405 extends out of the outlet end 404 of the tubular body 401.

As shown in FIGS. 37A and 46, the leading portion of the generally cylindrical rear portion 426 of the mouthpiece 405 is formed with one or more low annular ribs 428. The annular ribs 428 engage the inner surface 415 of the tubular body 401, helping to seal the end of the tubular body 401.

As shown in FIGS. 37 and 38, the generally cylindrical rear portion 426 of the mouthpiece is provided with a shoulder step 429 where the rear end portion 426 of the mouthpiece widens from a diameter that can fit within the tubular body 401 to a diameter that is substantially as wide as the tubular body 401.

As shown in FIGS. 37 and 38, the mouthpiece 405 is formed with a cylindrical chamber 430 that can receive a removable filter 431. The filter 431 is inserted through an opening 432 in the rear end 407 of the mouthpiece 405. The diameter of the cylindrical chamber 430 is sized to snugly fit the filter 431 such that all of the smoke drawn through the tubular body 410 and the mouthpiece 405 is forced through the filter 431. The removable filter 431 is preferably cylindrical.

As shown in FIGS. 57 and 57A, the inlet end 403 of the tubular body 401 is shaped in a particular manner to assist with loading ground herbaceous material into an inlet end 403 of the tubular body 401. The inlet end 403 of the tubular body 401 is formed with an inlet edge 430 that has width “X” that is less than the thickness “Y” of the wall of the tubular body 401. A sloping surface 431 connects the inlet edge 430 to the outer surface 432 of the tubular body 401. The sloping surface 432 is set at an angle of “Z” to the inner surface 415 of the tubular body 401. The reduced thickness of inlet edge 430 makes the inlet end less sharp so as the user is less likely to be cut when the user who is handling the smoking device 400.

As best shown in FIGS. 37, 38 and 41, the smoking device 400 is preferably formed so that the components of the smoking device 400 can be easily assembled and disassembled without tools. In one embodiment of the smoking device as best shown in FIG. 41, the narrowed front portion 427 of the mouthpiece 405 is formed as a split, pronged member having a first spring prong 432 and a second spring prong 433. The first and second spring prongs 432 and 433 are formed so that in a rest position they cannot receive the rear end 410 of the plunger 408, but when the rear end 410 of the plunger 408 is inserted between the first and second spring prongs 432 and 433 the spring prongs will expand in a spring-like manner and receive the rear end of the plunger 410 and clampingly engage the rear end 410 of the plunger 408.

The first and second spring prongs 432 and 433 are preferably formed with inner surfaces 434. The inner surfaces 434 of the first and second spring prongs 432 and 433 are each preferably formed with an indentation 435 that receives the rearward annular extension 425 of the plunger 408. The first and second spring prongs 432 and 433 are also preferably formed with first and second end edges 436 and 437 that interface with the forward annular extension 424 disposed on the forward side of the annular seat 423 of the plunger 408. In this manner the mouthpiece 405 can interlocking engage with the plunger 408 at a predetermined location.

As shown in FIG. 39, the narrowed front portion 427 of the mouthpiece 405 can be formed as generally cylindrical member with flattened portions 438 and transverse channels 439 that have openings that receive the legs of a u-shaped spring clip 440 that interlocks with the annular seat 423 at the rear end 410 of the plunger 408.

As shown in FIGS. 37 and 38, the ejection spring 411 is used to eject smoked herbaceous materials from the inlet end 403 of the tubular body 401. FIG. 37 shows the ejection spring in its rest position with a substantial portion of the generally cylindrical rear portion 426 of the mouth piece 405 not seated in the tubular body. The flaring head 418 of the plunger 408 is situated such that the openings 416 near the inlet end of the tubular body are disposed forwardly of the forward surface 441 of the flaring head 418 of the plunger 408. This creates a space in front of the forward surface 441 of the flaring head, encapsulated by the inlet end 403 of the tubular body that can receive herbaceous materials to be burned and smoked. The openings 416 at the inlet end 403 of the tubular body 401 are situated and extend most of the way between the inlet edge 430 and forward surface 441 of the flaring head 419 such that the herbaceous material in the space between the forward surface 441 of the flaring head 419 and the inlet edge 430 has sufficient access to the ambient air to burn evenly.

The mouthpiece 405 is formed with a smoke channel 442 such that smoke drawing from the inlet end 403 of the tubular body 401 can be drawn through the mouthpiece 405.

As shown in FIGS. 46, 53, 53A and 54, in one embodiment of the invention, the narrowed front portion 427 of the mouthpiece 405 is preferably formed with indented seats 443 on the first and second prongs 432 and 433 over which the rear end 413 of the ejection spring 411 clampingly sits so that ejection spring 411 is removably attached and fixed to the mouthpiece 405, such that forward movement of the mouthpiece 405 toward the inlet end 403 of the tubular body 401 will compress the ejection spring 411. The forwarded movement of the mouthpiece 405 will push the plunger 408 forward in the tubular body 401 such that the flaring head 418 of the plunger 408 will be pushed outwardly of the inlet end 403 of the tubular body, ejecting residue and ash from the smoked herbaceous materials. As the mouthpiece 405 is pushed forward, the ejection spring 411 is compressed against the inner shoulder 414 of the tubular body, and when forward pressure on the mouthpiece 405 is released, the ejection spring will decompress and return the mouthpiece 405 to its rest position.

When the mouthpiece 405 is pushed toward the inlet end 403 of the tubular body, the travel of the mouthpiece 405 is limited by the shoulder step 429 as shown in FIG. 38. The shoulder step 429 interfaces with the edge 97 on the outlet outlet end 404 of the tubular body 401 and is prevented from further entering the tubular body 401.

As shown in FIG. 39, in a different embodiment of the smoking device 400 of the present invention, the narrowed front portion 427 of the mouthpiece 405 can be formed with a forward bearing surface 444 against which the rear end 413 of the ejection spring 411 can bear such that forward movement of the mouthpiece 405 toward the inlet end 403 of the tubular body 401 will compress the ejection spring 411. The forwarded movement of the mouthpiece 405 will push the plunger 408 forward in the tubular body 401 such that the flaring head 418 of the plunger 408 will be pushed outwardly of the inlet end 403 of the tubular body, ejecting residue and ash from any smoked herbaceous materials. As the mouthpiece 405 is pushed forward, the ejection spring 411 is compressed against the inner shoulder 414 of the tubular body, and when forward pressure on the mouthpiece 405 is released, the ejection spring will decompress and return the mouthpiece 405 to its rest position.

As shown in FIG. 57, when herbaceous material is burned in the inlet end 403 of the tubular body 401 and suction is applied to the mouthpiece 405 by a user the smoke is drawn between the radial spokes 419 of the flaring head 418 and through the tubular body 401 and around the ejection spring 411 and over the roughened surface of the plunger 408 and then through the mouthpiece 405. This convoluted path helps cool the smoke and allows for the more complete burning of embers that may be drawn in with the smoke.

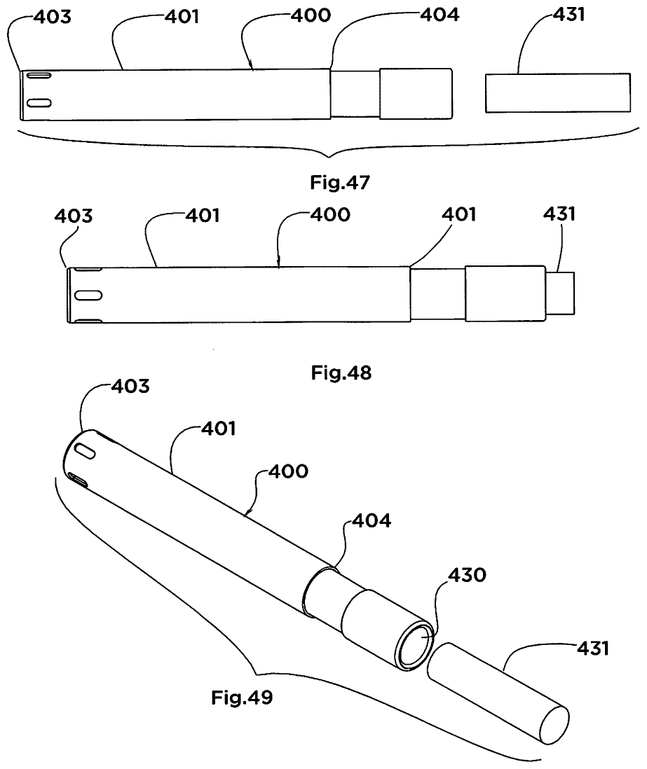

As shown in FIGS. 47-49, the air slots or openings 416 are positioned radially around the circumference of the inlet end 403 of the tubular body 401, enabling a more uniform and complete burning of the material.

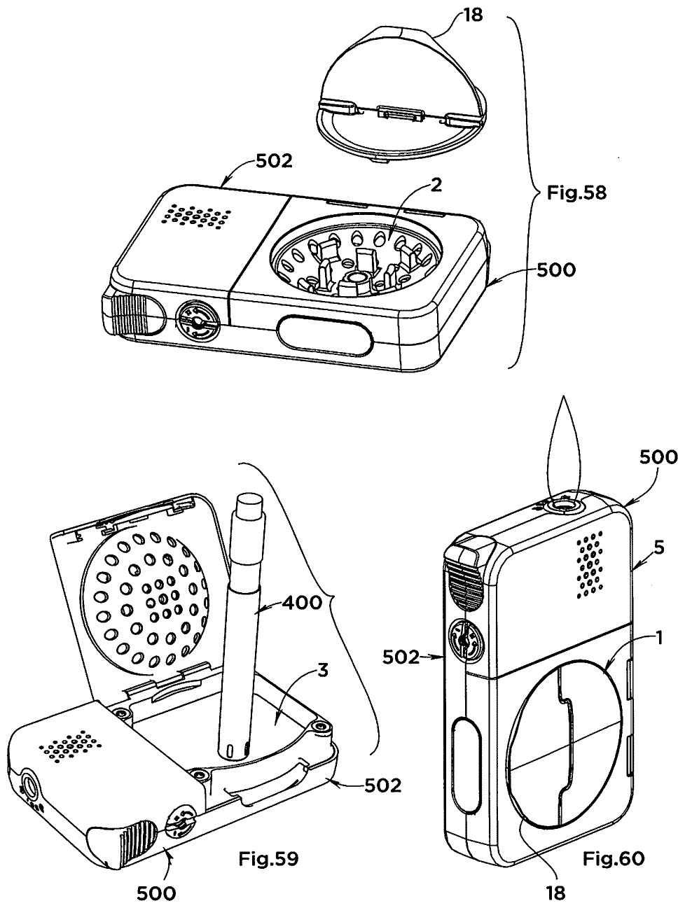

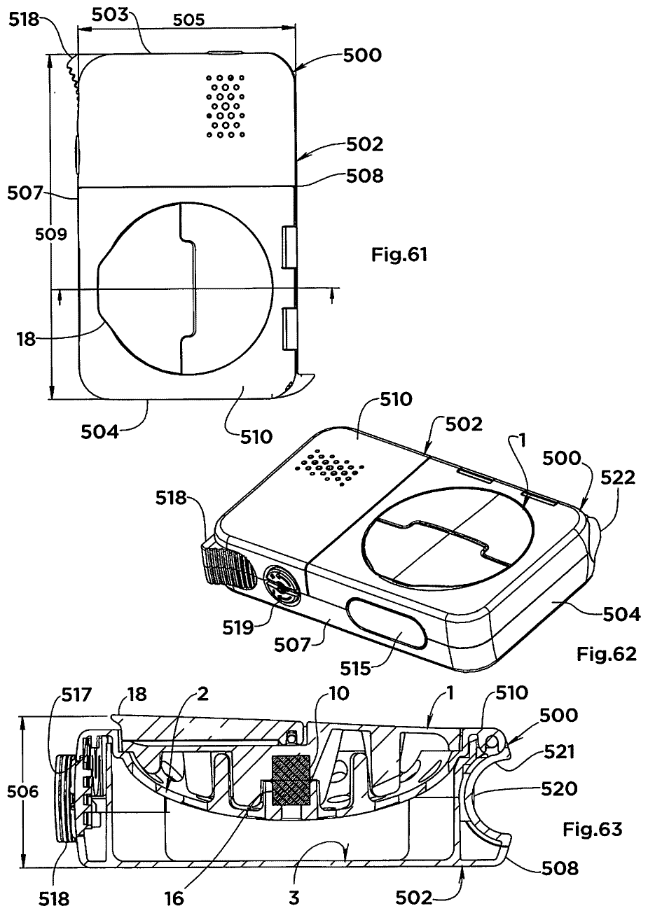

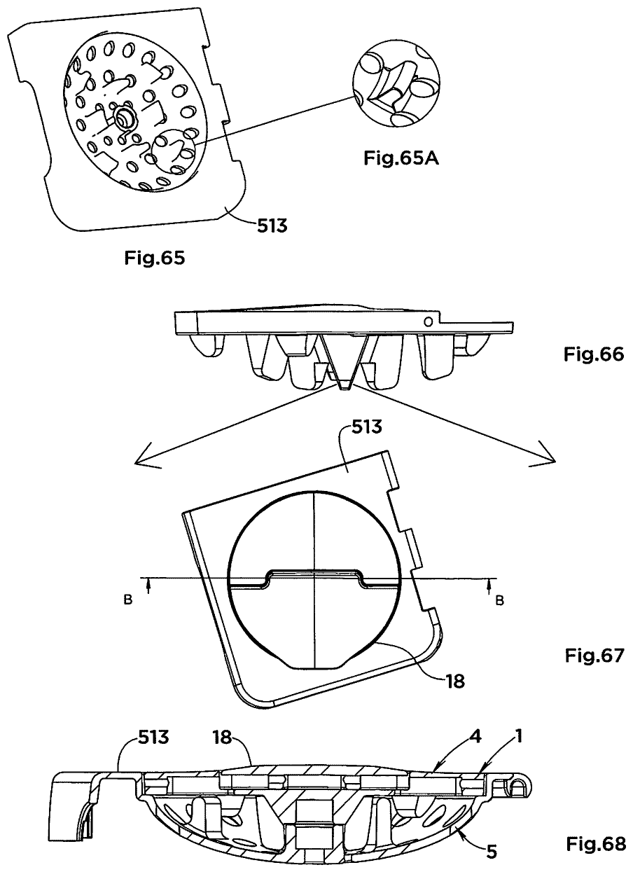

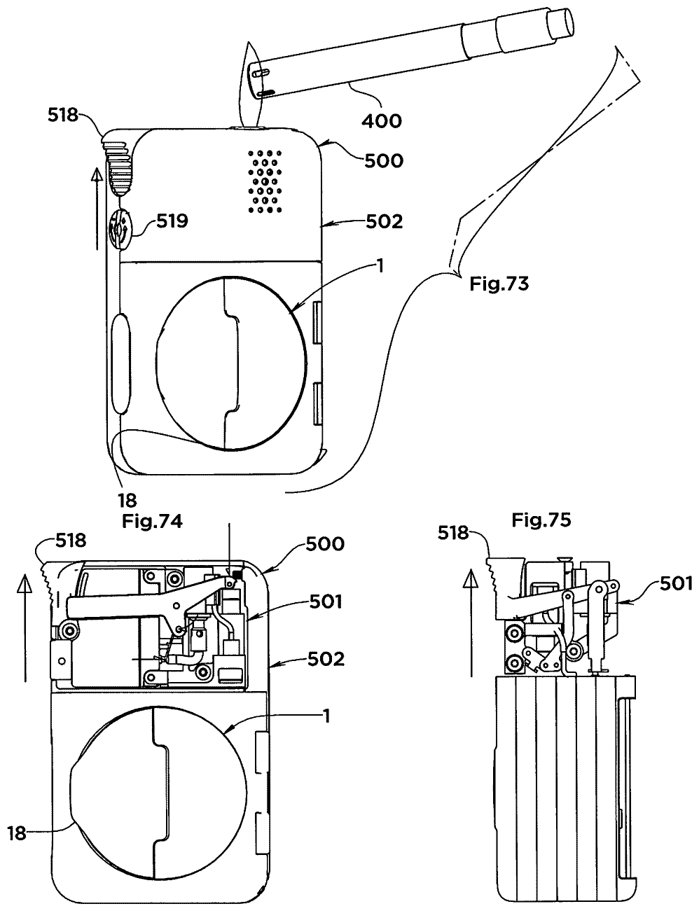

As shown in FIGS. 58-74, the present invention also includes a case 500 for carrying a single dose smoking device 400, a grinder 1, a lighter 501, and an area for storing ground herbaceous material which can either be in the grinder 1 or in a separate hopper sector 3. The case has a main body 502 which is formed in the shape of a rectangular box. The main body 502 has top and bottom ends 503 and 504 which have a width dimension 505 that is larger than the depth dimension 506. The main body 502 has right and left side surfaces 507 and 508 which have a height dimension that is larger than the depth dimension 506. The main body 502 also has front and back surfaces 510 and 511 where the front and back surfaces 510 and 511 are the largest surfaces of the main body 502.

The lighter 501 is contained in the upper portion of the main body 502 with the exit port 512 for the flame being located in the top end 503.

The grinder 1 is contained in the lower portion of the main body 502 below the lighter 501. The grinder 1 is incorporated in an access door 513 that covers the lower portion of the front surface 510 of the main body 502. The access door 513 preferably opens on a hinge 514 that is located at an edge on the lower portion of the main body 502 between the right side surface 508 and the front surface 510. The access door has a spring-actuated latch 515 that is located on the lower portion of the main body on the left side surface 507. A spring 516 triggers the latching mechanism on the access door 513 with latching points 517 on the main body 502.

The lighter 501 has a trigger 518 that is located on the left side surface 507 of the main body 502, and the trigger 518 is preferably actuated by sliding the trigger 518 upwardly along the left side surface 507 of the main body. An adjustment mechanism 519 for the flame is located on the left side surface 507 of the main body 502 below the trigger 518.

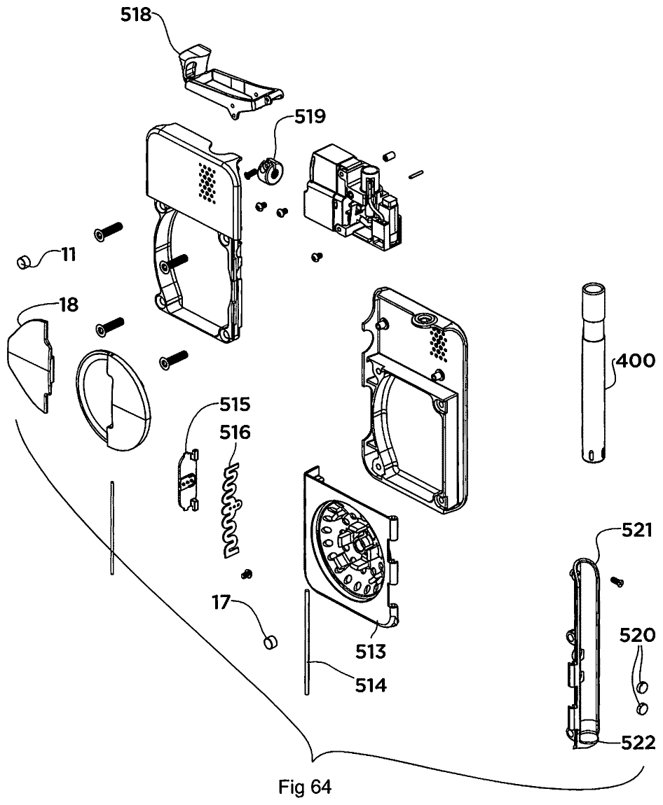

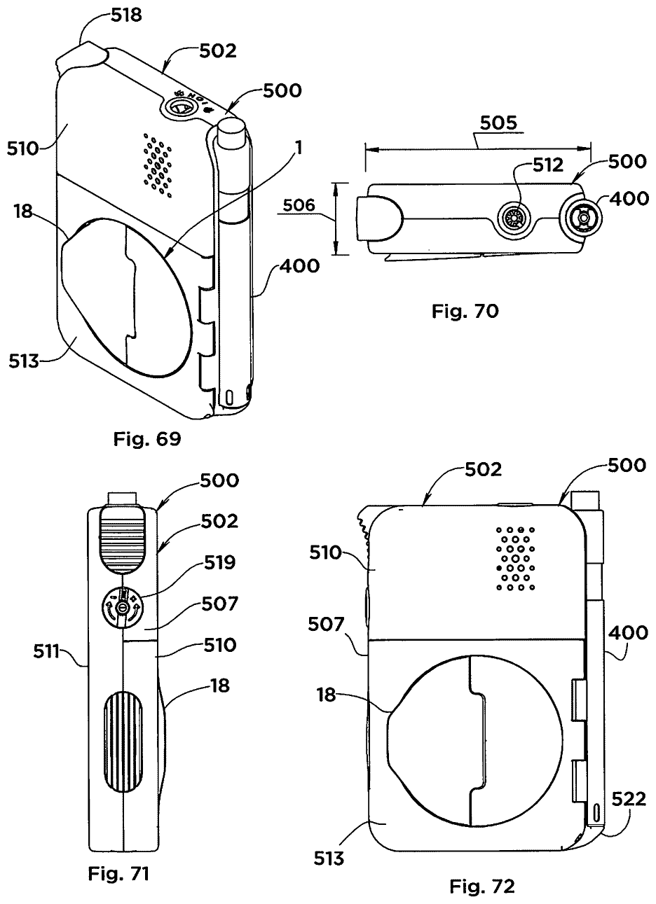

As shown in FIG. 64, in one embodiment of the invention the smoking device 400 is connected to the device with the use of magnets 520 that are set in the right side surface 508 of the case 500. The right side surface 508 of the case 500 is formed with a concave nest 521 that closely conforms to the shape of the smoking device 400. The concave nest 521 for the smoking device 400 is open on one side. As shown in FIGS. 69 and 72, the present invention also provides a cap 522 for the smoking device 400 that is part of the case 500. The cap 500 or protrusion is formed as a shelf on which the inlet end 403 of the smoking device 400 rests.

The present invention provides a reduced form-factor for the case 500. The bottom grinder element 5 is built into the access door 513, and the top grinder element 4 seals the grinder sector 2 as described above and utilizes a flip-up handle 18 for the grinder 1. The flip-up handle 18 can be rotated 90 degrees so that the user has access to a larger gripping surface and can securely rotate the top grinder element 4. When not in use the flip-up handle 18 folds into the upper surface 19 of the top grinder element, taking up a minimum amount of space. As shown in FIG. 59, the bottom grinder element 5 in the access door 513 is formed with filtration holes 53 and the ground herbaceous materials pass through the filtration holes 53 into the hopper sector 3.

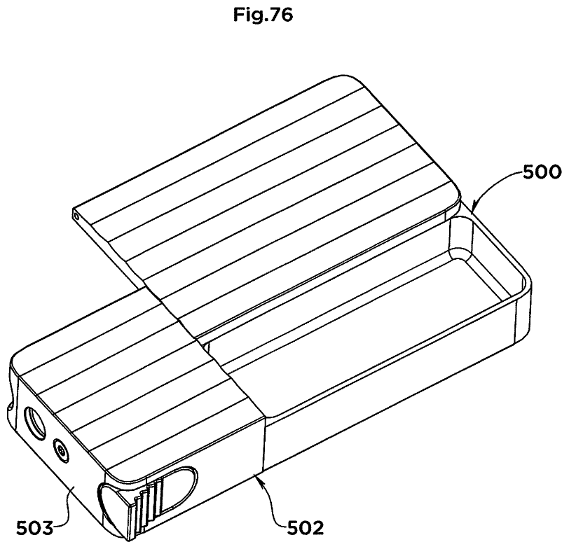

FIGS. 75 and 76 show a schematic view of an alternate case 500 of the present invention that has a similar arrangement of parts of the embodiment of the case described above, but does not include a grinder 1. The case 500 has a lighter and a storage area for ground herbaceous material that is sealed by an access door 513. The case 500 has a concave nest 521.

1. A herb grinder comprising:
a. a top grinder element having a first cylindrical sidewall extending from a roof, the roof having a first set of protruding bosses disposed in a plurality of first concentric rings on a lower surface of the roof,
b. a bottom grinder element having second cylindrical sidewall extending from a floor having a second set of protruding bosses disposed in a plurality of second concentric rings on an upper side of the floor,
c. the bottom grinder element matingly engaging with the top grinder element to create a grinder sector so that the first and second cylindrical sidewalls slidingly engage with each other when one of the top grinder element and the bottom grinder element is rotated with respect to the other of the top grinder element and the bottom grinder element and the first and second sets of protruding bosses slidingly engage with each other to create a shearing motion on any herbaceous material disposed in the grinder sector, and wherein;
d. the bosses of either top grinder element or the bottom grinder element or both the bosses of the top grinder element and the bottom grinder element are of varying heights along a radius of the top grinder element and along a radius of the bottom grinder element.

2. The herb grinder of claim 1, wherein:
the bosses of the top grinder element and the bottom grinder element are relatively shorter at the periphery of the top and bottom grinder elements compared to relatively taller bosses near centers of the top and bottom grinder elements.

3. The herb grinder of claim 1, wherein:
the bosses at the outer portions of the top and bottom grinder elements are shorter than the bosses closer to centers of the top and bottom grinder elements.

4. The herb grinder of claim 1, wherein:
the bottom grinder element is formed with a bowl-shaped floor.

5. The herb grinder of claim 1, wherein:
the bottom grinder element is deepest near or at the center of the bottom grinder element and the floor extends upwardly therefrom towards the top grinder element.

6. The herb grinder of claim 1, wherein:
the floor extends upwardly in a curved manner from a center of the bottom grinder element to a periphery of the floor of the bottom grinder element.

7. The herb grinder of claim 6, wherein:
the bosses of the bottom grinder element extend to a similar height.

8. The herb grinder of claim 7, wherein:
the bosses extending from an upper surface of the floor of the bottom grinder element extend very closely to the lower surface of the roof of the top grinder element, and the lower surface of the roof is substantially flat.

9. The herb grinder of claim 1, wherein:
a hopper sector communicates with the top and bottom grinder elements through passages in the bottom grinder element.

10. A herb grinder, comprising:
a. a combined grinder and wiper having a plurality of blades and a bottom grinder element having a plurality of upstanding bosses,
b. the bottom grinder element being assembled with the combined grinder and wiper in a manner that allows for rotation of the combined grinder and wiper with respect to the bottom grinder element and when the grinder is assembled, a top wiper actuation member mechanically engages with the combined grinder and wiper such that rotation of the top wiper action member in a given direction causes the rotation of the combined grinder and wiper in the same direction and wherein rotating the combined grinder and wiper and the bottom grinder element with respect to each other traps herbaceous materials in between the combined grinder and wiper and the bottom grinder element, and rotating the combined grinder and wiper and the bottom grinder element with respect to each other causes the bosses projecting from a floor of the bottom grinder element to slide past in reciprocating arrangement spaced swiping members on the lower portions of the blades of the combined grinder and wiper, causing a shearing action on the herbaceous material.

11. The herb grinder of claim 10, wherein:
the swiping members are spaced apart from each other by recesses that are shaped to allow the combined grinder and wiper to extend closely to an upper surface of the floor of the bottom grinder element without interference from the bosses when the combined grinder and wiper is rotated with respect to the bottom grinder element.

12. The herb grinder of claim 10, wherein:
the bosses and the swiping members are disposed in concentric arrangements that allow the bosses and the swiping members to pass, and not hit each other when rotated with respect to each other.

13. The herb grinder of claim 10, wherein:
the blades and the swiping members are made with sloping surfaces such that when the combined grinder and wiper is turned in a first direction, upper portions of the blades lead most of portions of the swiping members which constitute lower portions of the blades, and when the combined grinder and wiper is turned in a second direction the upper portions of the blades trail most of the portions of the swiping members which constitute the lower portions of the blades.

14. The herb grinder of claim 10, wherein:
the blades and the swiping members are preferably made with curved or skewed surfaces along radial extensions and the blades curve in a similar manner such that when the combined grinder and wiper is turned in a first direction, lower portions of inner portions of the blades lead the lower portions of the outer portions of the blades and when the combined grinder and wiper is turned in a second direction the lower portions of the outer portions of the blades lead the lower portions of the inner portions of the blades.

15. The herb grinder of claim 10, wherein:
the bosses of the bottom grinder element are relatively shorter at the periphery of the bottom grinder element compared to relatively taller bosses near a center of the bottom grinder element.

16. The herb grinder of claim 1, wherein:
the bosses at the outer portion of the bottom grinder element are shorter than the bosses closer to a center of the bottom grinder element.

17. The herb grinder of claim 10, wherein:
the bottom grinder element is formed with a bowl-shaped floor.

18. The herb grinder of claim 10, wherein:
the bottom grinder element is deepest near or at the center of the bottom grinder element and the floor extends upwardly therefrom towards the top wiper actuation member.

19. The herb grinder of claim 16, wherein:
the bosses of the bottom grinder element extend to a similar height.

20. A smoking device comprising:
a. a tubular body having a continuous longitudinal recess that extends the length of the tubular body, the tubular body having an inlet end and an outlet end,
b. a mouthpiece with an internal air passage, having a front end and a rear end with the front end connecting to the outlet end of the tubular body,
c. a plunger having a front end and a rear end with the mouthpiece connecting to the rear end of the plunger,
d. an ejection spring having a front end and a rear end, the ejection spring being contained in the tubular body with the rear end of the ejection spring being connected to or in abbutting relation with the front end of the mouthpiece and the front end of the ejection spring bearing upon an inner shoulder of the tubular body near the inlet end of the tubular body.

21. The smoking device of claim 20, wherein:
the tubular body has a plurality of openings formed near the inlet end of the tubular body.

22. The smoking device of claim 20, wherein:
the plunger is formed as an elongated member with an elongated shaft that extends between the front end and the rear end of the plunger with the front end of the plunger being formed with a flaring head consisting of a plurality of radial spokes extending from the shaft.

23. The smoking device of claim 20, wherein:
the flaring head has a rear bearing surface that bears against a front edge of the inner shoulder of the tubular body when the components of the smoking device are connected to each other and the ejection spring is not extended or compressed with the flaring head being shaped so that smoke from burning herbaceous materials at the inlet end of the tubular body can pass between portions of the radial spokes near an axis of the plunger and around the inner shoulder of the tubular body and travel to the outlet end of the tubular body.

24. A case for carrying a single dose smoking device, comprising:
a. a grinder, a lighter, and an area for storing ground herbaceous material,
b. the case having a main body which is formed in the general shape of a rectangular box, the main body having top and bottom ends which have a width dimension that is larger than the depth dimension, the main body having right and left side surfaces which have a height dimension that is larger than the depth dimension, and the main body having front and back surfaces, where the front and back surfaces are the largest surfaces of the main body, where the lighter is contained in the upper portion of the main body with an exit port for the flame issued by the lighter being located in the top end of the main body, and the grinder is contained in a lower portion of the main body below the lighter, and the grinder is incorporated in an access door that covers the lower portion of the front surface of the main body, and the single dose smoking device is releasably attached to the right side surface of the main body.

25. The case of claim 24, wherein:
the access door preferably opens on a hinge that is located at an edge on the lower portion of the main body between the right side surface and the front surface.

26. The case of claim 24, wherein:
the lighter has a trigger that is located on the left side surface of the main body and the trigger is preferably actuated by sliding the trigger upwardly along the left side surface of the main body.

27. The case of claim 24, wherein:
the single does smoking device is connected to the right side surface of the main body by one or more magnets that are set in the right side surface of the main body.

28. The case of claim 24, wherein:
the right side surface of the case main body is formed with a concave nest that closely conforms to the shape of the single dose smoking device.

29. The case of claim 28, wherein:
the concave nest for the single dose smoking device is open on one side.

30. The case of claim 28, wherein:
the right side surface of the main body has a protruding shelf that covers an inlet end of the single dose smoking device when the single dose smoking device is received by the concave nest in a particular orientation and position.
